(19) United States
(12) Patent Application Publication
(10) Pub. No.: US 2026/0065565 A1
(43) Pub. Date: Mar. 5, 2026

(54) METHODS, SYSTEMS, AND COMPUTER PROGRAM PRODUCTS FOR GENERATING 3D HUMAN POSE AND MOVEMENT ESTIMATION FROM MONOCULAR IMAGE INFORMATION

(71) Applicant: The University of North Carolina at Charlotte, Charlotte, NC (US)

(72) Inventors: Pu Wang, Waxhaw, NC (US); Muhammad Usama Saleem, Charlotte, NC (US); Ekkasit Pinyoanuntapong, Charlotte, NC (US); Parshwa Shah, Surat (IN); Foram Shah, Ahmedabad (IN)

(21) Appl. No.: 19/318,526

(22) Filed: Sep. 4, 2025

Related U.S. Application Data
(60) Provisional application No. 63/690,554, filed on Sep. 4, 2024.
(60) Provisional application No. 63/741,586, filed on Jan. 3, 2025.
(60) Provisional application No. 63/764,643, filed on Feb. 28, 2025.
(60) Provisional application No. 63/774,986, filed on Mar. 20, 2025.

(51) Int. Cl. G06T 13/40; G06N 3/0455; G06T 7/73; G06T 17/20; G06V 10/766

(52) U.S. Cl. CPC G06T 13/40; G06N 3/0455; G06T 7/73; G06T 17/20; G06V 10/766; G06T 2207/20081

(57) ABSTRACT

A computer-implemented method includes converting by a pose tokenizer, based on a learned codebook, pose parameters of a body into a sequence of discrete pose tokens; randomly masking a portion of the sequence of discrete pose tokens; predicting the randomly masked sequence of discrete pose tokens based on multi-scale features extracted from a monocular image by an image conditioned masked transformer; optimizing the sequence of discrete pose tokens by aligning a re-projected three-dimensional (3D) pose with an estimated two-dimensional (2D) pose; directly regressing, from the multi-scale features, a shape parameter of the body and a weak perspective camera parameter; and generating a 3D mesh reconstruction of the body based on the shape parameter and the weak perspective camera parameter.

### CROSS-REFERENCE TO RELATED APPLICATIONS

The present application claims priority to U.S. Provisional Patent Application Ser. No. 63/690,554 (hereinafter '554 application), filed Sep. 4, 2024, U.S. Provisional Patent Application Ser. No. 63/741,586 (hereinafter '586 application), filed Jan. 3, 2025, U.S. Provisional Patent Application Ser. No. 63/764,643 (hereinafter '643 application), filed Feb. 28, 2025, and U.S. Provisional Patent Application Ser. No. 63/774,986 (hereinafter '986 application), filed Mar. 20, 2025, the entire content of each of these provisional patent applications is incorporated by reference herein as if set forth in its entirety.

### FIELD

The present disclosure relates generally to estimating the pose and movements of a character based on image information, video information, and one or more control signals.

### BACKGROUND

Three-dimensional (3D) pose estimation from two-dimensional (2D) images has advanced significantly, moving from simple convolutional neural network (CNN) regressors to diffusion models and parametric mesh fitting. While benchmarks like Human3.6M are largely solved, real-world robustness remains a big hurdle, especially with occlusion, depth ambiguity, and domain shift. Existing models may oversimplify anatomical structures, limiting their ability in capturing true joint locations and movements, which may reduce their applicability in biomechanics, healthcare, and robotics. Biomechanically accurate pose estimation typically requires costly marker-based motion capture systems and optimization techniques in specialized labs.

Text-driven human motion generation has recently gained significant attention due to the semantic richness and intuitive nature of natural language descriptions. This approach has broad applications in animation, film, virtual/augmented reality (VR/AR), and robotics. While text descriptions offer a wealth of semantic guidance for motion generation, they often fall short in providing precise spatial control over specific human joints, such as the pelvis and hands. As a result, achieving natural interaction with the environment and fluid navigation through 3D space remains a challenge.

Dance motion generation has recently garnered significant attention owing to the intuitive rhythmic structure and semantic richness that music can offer in guiding human motion. This task finds broad applications in choreography, animation, virtual and augmented reality, and robotics, where the ability to synthesize lifelike, context-aware dance movements is desired. Recent efforts in dance generation mainly focus on synthesizes realistic dance movements, which are aligned with music notes that provide valuable cues-such as rhythm, beat, and tempo. Despite these ongoing efforts, existing methods still face fundamental limitations.

Primarily, these models typically accept only music modality as input. Music is vital for choreography, providing rhythm, mood, and cues for synchronized movements. Its tempo and dynamics influence the choreography's speed and intensity, while melody and harmony inspire the theme and style. Current models struggle from simultaneously generating high-fidelity and diverse dance movements, while precisely aligning with the music tempo and dynamics. In addition, current models lack text inputs, which choreographers may choose to use to reduce or minimize music reliance to foster more original dance creation based on textual narratives. Additionally, current models often do not allow for user edits to the generated outcomes, confining them to single-instance, automatic dance creations. This limitation is significant as iterative refinement and prototyping are desirable for fine-tuning choreographic ideas and dance movements, which are a key to successful choreography creation.

### SUMMARY

According to some embodiments of the disclosure, a computer-implemented method comprises performing, by one or more processors, operations comprising: converting by a pose tokenizer, based on a learned codebook, pose parameters of a body into a sequence of discrete pose tokens; randomly masking a portion of the sequence of discrete pose tokens; predicting the randomly masked sequence of discrete pose tokens based on multi-scale features extracted from a monocular image by an image conditioned masked transformer; optimizing the sequence of discrete pose tokens by aligning a re-projected three-dimensional (3D) pose with an estimated two-dimensional (2D) pose; directly regressing, from the multi-scale features, a shape parameter of the body and a weak perspective camera parameter; and generating a 3D mesh reconstruction of the body based on the shape parameter and the weak perspective camera parameter.

In other embodiments, the one or more processors comprise the pose tokenizer and the image conditional masked transformer; and the method further comprises: training the pose tokenizer using Vector Quantized Variational Autoencoders (VQ-VAE).

In still other embodiments, the post parameters comprise a representation of a continuous human pose and a representation of rotations of skeletal joints.

In still other embodiments, the image conditional masked transformer comprises an image encoder and a masked transformer decoder with multi-scale deformable cross attention.

In still other embodiments, optimizing the sequence comprises optimizing the sequence by using a two-dimensional pose-guided sampling strategy.

In still other embodiments, the method further comprises: training the image conditional masked transformer to predict the randomly masked sequence of discrete pose tokens by learning a conditional categorical distribution of sequences of discrete pose tokens.

In still other embodiments, predicting the randomly masked sequence comprises: predicting the randomly masked sequence using an iterative decoding process.

In still other embodiments, the iterative decoding process comprises: predicting high-confidence sequences of the discrete pose tokens; progressively refining the high-confidence sequences by masking low-confidence sequences of the discrete pose tokens; and leveraging both image semantics of the 2D image and inter-token dependencies.

In still other embodiments, the 3D mesh reconstruction is used for computer vision including character animation for video games and movies, metaverse, human-computer interaction, or sports performance optimization.

According to some embodiments of the disclosure, a computer-implemented method comprises performing, by one or more processors, operations comprising: extracting from a monocular image a plurality of feature tokens that encode visual information using a vision transformer encoder; extracting multi-scale image features from the encoded visual information using a multi-query deformable transformer decoder to generate a three-dimensional (3D) mesh reconstruction of a body; and applying a spatial-temporal network to the 3D mesh to infer biomechanically accurate 3D poses of the body.

In further embodiments, extracting the plurality of feature tokens comprises: upsampling the plurality of feature tokens to produce feature maps at a plurality of resolutions.

In still further embodiments, applying the spatial-temporal network to the 3D mesh comprises: extracting virtual markers from the mesh; projecting positions of the virtual markers into a higher-dimensional space to generate a spatial embedding; and processing the spatial embedding using a plurality of convolutional layers of a spatial convolution encoder to generate a refined spatial feature embedding.

In still further embodiments, the method further comprises: predicting body scales and joint angles based on the refined spatial feature embedding by modeling dependencies of the refined spatial feature embedding across a plurality of frames of a motion sequence using a temporal transformer encoder.

In still further embodiments, the method further comprises: applying a loss function using a forward kinematics layer for both of the spatial convolution encoder and the temporal transformer encoder to maintain anatomical constraints in virtual markers.

In still further embodiments, the virtual markers are represented as a Biomechanical Skeleton (BSK) model.

In still further embodiments, the method further comprises: aligning the 3D poses of the body with one or more estimated two-dimensional (2D) poses.

According to some embodiments of the disclosure, a computer-implemented method comprises performing, by one or more processors, operations comprising: receiving a text prompt and a spatial control signal indicating spatial control conditions for positions of each joint of a character at each frame in a motion sequence; and creating, using a generative masked motion model, a physically plausible human motion sequence that aligns with the text prompt and follows the spatial control conditions.

In other embodiments, the method further comprises: training the generative masked motion model using text training data and spatial control training data to learn a conditional distribution of motion tokens representing the joints of the character.

In still other embodiments, the method further comprises: controlling a robot to move according to the physically plausible human motion sequence.

In still other embodiments, the method further comprises: displaying animated graphics according to the physically plausible human motion sequence.

In still other embodiments, creating the physically plausible human motion sequence comprises: processing a predicted conditional motion distribution of motion tokens representing the joints of the character so that generated motion, sampled from the plausible human motion sequence, adheres to the spatial control signal.

In still other embodiments, the text prompt includes descriptions of semantic guidance for motion generation.

In still other embodiments, the generative masked motion model includes: a motion tokenizer; and a text-conditioned masked transformer.

According to some embodiments of the disclosure, a computer-implemented method comprises performing, by one or more processors, operations comprising: receiving a text prompt and a music control signal indicating a rhythm and spatial control conditions for positions of each joint of a character at each frame in a motion sequence; and creating, using a triple-stream masked motion model, a physically plausible human motion sequence that rhythmically aligns with the music control signal while maintaining spatial coherence.

In further embodiments, the triple-stream masked motion model comprises a text-guided masked motion model, the method further comprising: training the text-guided masked motion model using text training data to learn a conditional distribution of motion tokens representing the joints of the character based on the text training data.

In still further embodiments, the triple-stream masked motion model comprises a music-guided masked motion model, the method further comprising: training the music-guided motion model using music control signal training data and the text training data to learn a conditional distribution of the motion tokens representing the joints of the character based on the music control signal training data and the text training data.

In still further embodiments, the triple-stream masked motion model comprises a pose-guided masked motion model, the method further comprising: training the pose-guided motion model using pose control signal training data and the text training data to learn a conditional distribution of the motion tokens representing the joints of the character based on the pose control signal training data and the text training data.

In still further embodiments, the method further comprises: refining the motion tokens during interference to adjust rhythm synchronization and coherent alignment with multimodal inference inputs including an inference text prompt and an inference music control signal.

According to some embodiments of the disclosure, a system comprises one or more processors and one or more memories configured to store processor-executable instructions that, when executed by the one or more processors, cause the one or more processors to perform operations comprising: converting by a pose tokenizer, based on a learned codebook, pose parameters of a body into a sequence of discrete pose tokens; randomly masking a portion of the sequence of discrete pose tokens; predicting the randomly masked sequence of discrete pose tokens based on multi-scale features extracted from a monocular image by an image conditioned masked transformer; optimizing the sequence of discrete pose tokens by aligning a re-projected three-dimensional (3D) pose with an estimated two-dimensional (2D) pose; directly regressing, from the multi-scale features, a shape parameter of the body and a weak perspective camera parameter; and generating a 3D mesh reconstruction of the body based on the shape parameter and the weak perspective camera parameter.

According to some embodiments of the disclosure, a system comprises one or more processors and one or more memories configured to store processor-executable instructions that, when executed by the one or more processors, cause the one or more processors to perform operations comprising: extracting from a monocular image a plurality of feature tokens that encode visual information using a vision transformer encoder; extracting multi-scale image features from the encoded visual information using a multi-query deformable transformer decoder to generate a three-dimensional (3D) mesh reconstruction of a body; and applying a spatial-temporal network to the 3D mesh to infer biomechanically accurate 3D poses of the body.

According to some embodiments of the disclosure, a system comprises one or more processors and one or more memories configured to store processor-executable instructions that, when executed by the one or more processors, cause the one or more processors to perform operations comprising: receiving a text prompt and a spatial control signal indicating spatial control conditions for positions of each joint of a character at each frame in a motion sequence; and creating, using a generative masked motion model, a physically plausible human motion sequence that aligns with the text prompt and follows the spatial control conditions.

According to some embodiments of the disclosure, a system comprises one or more processors and one or more memories configured to store processor-executable instructions that, when executed by the one or more processors, cause the one or more processors to perform operations comprising: receiving a text prompt and a music control signal indicating a rhythm and spatial control conditions for positions of each joint of a character at each frame in a motion sequence; and creating, using a triple-stream masked motion model, a physically plausible human motion sequence that rhythmically aligns with the music control signal while maintaining spatial coherence.

According to some embodiments of the disclosure, one or more non-transitory computer-readable media are configured to store processor-executable instructions that, when executed by one or more processors, cause the one or more processors to perform operations comprising: converting by a pose tokenizer, based on a learned codebook, pose parameters of a body into a sequence of discrete pose tokens; randomly masking a portion of the sequence of discrete pose tokens; predicting the randomly masked sequence of discrete pose tokens based on multi-scale features extracted from a monocular image by an image conditioned masked transformer; optimizing the sequence of discrete pose tokens by aligning a re-projected three-dimensional (3D) pose with an estimated two-dimensional (2D) pose; directly regressing, from the multi-scale features, a shape parameter of the body and a weak perspective camera parameter; and generating a 3D mesh reconstruction of the body based on the shape parameter and the weak perspective camera parameter.

According to some embodiments of the disclosure, one or more non-transitory computer-readable media are configured to store processor-executable instructions that, when executed by one or more processors, cause the one or more processors to perform operations comprising: extracting from a monocular image a plurality of feature tokens that encode visual information using a vision transformer encoder; extracting multi-scale image features from the encoded visual information using a multi-query deformable transformer decoder to generate a three-dimensional (3D) mesh reconstruction of a body; and applying a spatial-temporal network to the 3D mesh to infer biomechanically accurate 3D poses of the body.

According to some embodiments of the disclosure, one or more non-transitory computer-readable media are configured to store processor-executable instructions that, when executed by one or more processors, cause the one or more processors to perform operations comprising: receiving a text prompt and a spatial control signal indicating spatial control conditions for positions of each joint of a character at each frame in a motion sequence; and creating, using a generative masked motion model, a physically plausible human motion sequence that aligns with the text prompt and follows the spatial control conditions.

According to some embodiments of the disclosure, one or more non-transitory computer-readable media are configured to store processor-executable instructions that, when executed by one or more processors, cause the one or more processors to perform operations comprising: receiving a text prompt and a music control signal indicating a rhythm and spatial control conditions for positions of each joint of a character at each frame in a motion sequence; and creating, using a triple-stream masked motion model, a physically plausible human motion sequence that rhythmically aligns with the music control signal while maintaining spatial coherence.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the disclosure will be or become apparent to one with skill in the art upon review of the following drawings and detailed description. It is intended that all such additional systems, methods, articles of manufacture, and/or computer program products be included within this description, be within the scope of the present inventive subject matter and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a diagram illustrating the creation of a 3D mesh from one or more 2D images using SMPL (Skinned Multi-Person Linear Model) by estimating 3D body pose and shape parameters from 2D visual input;

FIG. 2 is a block diagram of a transformer model used in for generating 3D human pose and movement estimation from monocular image information according to some embodiments of the disclosure;

FIG. 3 is a block diagram of a Generative Human Mesh Reconstruction (GenHMR) architecture according to some embodiments of the disclosure;

FIG. 4 is a flowchart that illustrates operations of the GenHMR architecture according to some embodiments of the disclosure;

FIG. 5 is a block diagram of a BioPose architecture according to some embodiments of the disclosure;

FIG. 6 is a flowchart that illustrates operations of the BioPose architecture according to some embodiments of the disclosure;

FIG. 7 is a block diagram of a ControlMM architecture according to some embodiments of the disclosure;

FIG. 8 is a flowchart that illustrates operations of the ControlMM architecture according to some embodiments of the disclosure;

FIG. 9 is a block diagram of a DanceMosaic architecture according to some embodiments of the disclosure;

FIG. 10 is a flowchart that illustrates operations of the DanceMosaic architecture according to some embodiments of the disclosure;

FIG. 11 is block diagram of a data processing system that can be used to implement a system for generating 3D human pose and movement estimation from monocular image information according to some embodiments of the disclosure;

FIG. 12 is a block diagram of a predictive data analysis computing entity of FIG. 11 according to some embodiments of the disclosure; and

FIG. 13 is a block diagram of an external computing entity of FIG. 11 according to some embodiments of the disclosure.

### DETAILED DESCRIPTION

In the following detailed description, numerous specific details are set forth to provide a thorough understanding of embodiments of the disclosure. However, it will be understood by those skilled in the art that embodiments of the disclosure may be practiced without these specific details. In some instances, well-known methods, procedures, components, and circuits have not been described in detail so as not to obscure the disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Embodiments of the disclosure are described herein in the context of generating three-dimensional (3D) pose and/or movement estimation of a human based on two-dimensional (2D) image information, text information, and/or music information. It will be understood that the embodiments of the disclosure are applicable in general to other entities capable of 3D reconstruction and/or estimation of their movements over time, such as, but not limited to, animals, plants, vehicles, objects, and the like.

Embodiments of the disclosure are described herein in the context of processing monocular image information, text information, and/or music information using one or more Artificial Intelligence (AI) models to generate a 3D human pose and movement estimation therefrom. The AI models disclosed herein may be embodied in a variety of different ways including, but not limited to, one or more of the following AI systems: a multi-layer neural network, a machine learning system, a deep learning system, a large language model, a natural language processing system, and/or computer vision system. Moreover, it will be understood that the multi-layer neural network is a multi-layer artificial neural network comprising artificial neurons or nodes and does not include a biological neural network comprising real biological neurons. The AI models described herein may be configured to transform a memory of a computer system to include one or more data structures, such as, but not limited to, arrays, extensible arrays, linked lists, binary trees, balanced trees, heaps, stacks, and/or queues. These data structures can be configured or modified through the processing of monocular image information, text information, and/or music information to improve the efficiency of a computer system when the computer system operates in an inference mode to make an inference, prediction, classification, suggestion, or the like with respect to generate an estimation of 3D human pose or movement.

Recovering three-dimensional (3D) human mesh from monocular images is an important task in computer vision, with applications spanning diverse fields, such as character animation for video games and movies, metaverse, human-computer interaction, and sports performance optimization. However, recovering 3D human mesh from monocular images remains challenging due to inherent ambiguities in lifting 2D observations to 3D space. For example, some challenges and ambiguities relate to flexible body kinematic structures, complex intersections with the environment, and insufficient annotated 3D data. Thus, there is a need for an approach to monocular human mesh recovery that effectively addresses the longstanding challenges of depth ambiguity and occlusion.

To address and improve upon the limitations of existing methods, embodiments of the disclosure may provide a generative framework for 3D human mesh recovery from a single 2D image. Generative Human Mesh Reconstruction (GenHMR) according to certain embodiments comprises components including a pose tokenizer and an image conditional masked transformer. The framework may follow a two-stage training paradigm. In the first stage, the pose tokenizer is trained using Vector Quantized Variational Autoencoders (VQ-VAE), which converts the continuous human pose or sensor data, such as the rotations of skeletal joints, into a sequence of discrete pose tokens in a latent space, based on a learned codebook.

In the second stage, generative masking training, a portion of the sequence of discrete pose tokens is randomly masked. The image conditional masked transformer is then trained to predict the masked sequence of discrete pose tokens by learning the conditional categorical distribution of each sequence of discrete pose tokens, given the input image and the unmasked sequence of discrete pose tokens. Thus, GenHMR according to some embodiments is able to learn through generative masking training, explicit probabilistic mapping from the 2D image to the human pose. Leveraging this feature, uncertainty guided iterative sampling during inference defines how the model decodes multiple sequences of discrete pose tokens simultaneously in each iteration by sampling from the learned image conditioned pose distributions. The sequence of discrete pose tokens with low prediction uncertainties are kept and the others are re-masked and re-predicted in the next iteration. This feature allows GenHMR to iteratively reduce 2D-to-3D mapping uncertainties and progressively correct the wrong joint rotations to improve the mesh reconstruction accuracy. To further refine the reconstruction quality, 2D pose-guided refinement directly optimizes the decoded pose tokens in the latent space, with an objective to force the projected 3D body mesh to align with the 2D pose clues.

Traditionally, marker-based motion capture systems have been a standard for obtaining biomechanically accurate 3D pose data. These systems utilize multiple cameras to track reflective markers placed on the human body in controlled laboratory environments. The captured marker data is then processed using sophisticated biomechanical optimization systems, such as OpenSim, which often requires skilled professionals to configure and refine. Although these marker-based systems generally provide high accuracy, they are expensive, labor-intensive, and impractical for use outside of specialized labs, particularly in dynamic, real-world environments. Conversely, significant advancements have been made in 3D pose estimation from monocular videos (single-camera footage), where deep neural networks are used to infer 3D poses, specifically, the rotation angles of body joints, from 2D image sequences, leveraging parametric human body models like SMPL. While monocular pose estimation offers greater accessibility compared to traditional marker-based systems, it may face notable limitations due to the anatomical simplifications inherent in body models like SMPL. These body models are designed to produce visually plausible poses, but fail to achieve biomechanical accuracy, particularly in joint positioning and skeletal movements.

To address these and other challenges, embodiments of the present disclosure provide a BioPose, a learning-based framework for biomechanically accurate 3D human pose estimation from monocular videos. In some embodiments, BioPose may include three core components: a multi-query human mesh recovery model (MQ-HMR), a neural inverse kinematics (NeurIK) model, and a 2D-informed pose refinement technique. The MQ-HMR model uses a multiquery deformable transformer to extract fine-grained, multiscale image features from monocular video frames, enabling precise recovery of a 3D human mesh. This model may simultaneously estimate 3D body pose, shape parameters, and camera parameters, resulting in an accurate and detailed body mesh. In the next stage, the NeurIK model treats the recovered mesh vertices as virtual markers and uses a spatial-temporal network to regress biomechanically accurate 3D poses. This process may be guided by the biomechanical skeleton model with anatomical realism, ensuring the predicted poses adhere to human biomechanics, such as anatomical locations and degrees of freedom of the joints. To further enhance accuracy, BioPose introduces a 2D informed refinement step during inference, optimizing pose queries in latent space to align the predicted 3D poses with 2D pose cues from the video. This refinement corrects 3D-to-2D projection discrepancies, ensuring both visual coherence and biomechanical precision.

A few controllable motion generation models have been developed to synthesize realistic human movements that align with both text prompts and spatial control signals. However, existing solutions may face significant difficulties in generating high-fidelity motion with precise and flexible spatial control while ensuring real-time inference. In particular, current models may struggle to support both sparse and dense spatial control signals simultaneously. For instance, some models excel at generating natural human movements that traverse sparse waypoints, while others are more effective at synthesizing motions that follow detailed trajectories specifying human positions at each time point. Recent attempts to support both sparse and dense spatial inputs may encounter issues with control precision; the generated motion often is not aligned well with the control conditions. Besides unsatisfied spatial flexibility and accuracy, the quality of motion generation in controllable models generally remains suboptimal, as evidenced by much worse FID scores compared to models that rely solely on text inputs. Moreover, most current methods use motion-space diffusion models, applying diffusion processes directly to raw motion sequences. While this design facilitates the incorporation of spatial control signals, the redundancy in raw data introduces computational overhead, resulting in slower motion generation speeds.

To address these challenges, ControlMM, according to some embodiments of the disclosure, provides an approach that integrates spatial control signals into generative masked motion models that excels in high-quality and fast motion generation. ControlMM, according to some embodiment, may provide real-time, high-fidelity, and high-precision controllable motion generation simultaneously. In some embodiments, ControlMM uses masked consistency modeling, which incorporates spatial guidance into a Masked Motion Model, which results in higher generation quality, more precise control, accelerated generation, and broader applications compared to existing methods.

Music-driven motion generation requires temporal synchronization between motion and musical rhythm. Early methods relied on motion retrieval and rule-based approaches, which produced rhythmically aligned but repetitive dance sequences. Deep learning models, such as LSTMs, GANs, and transformers, have significantly improved motion expressiveness and adaptability. Autoregressive dance generation model leverages GPT-like next-token prediction to improve rhythmic consistency while maintaining diversity. However, the sequential motion generation sequentially, rather than bidirectional modeling, often leads to misalignment between beats and movements. Recently, diffusion-based models, such as FineDance, Lodge, and EDGE further improved dance synthesis quality, They are still struggling, however, to generate diverse and high-fidelity dance motions aligned with music beats and styles. In addition, their iterative denoising process results in significant inference delays, making them unsuitable for real-time applications. Moreover, except EDGE, existing models lack the editing capacity, which may prevent interactive choreography applications. DanceMosaic, according to some embodiments of the disclosure aims to address the limitations of the existing methods, which can simultaneously achieve high-quality, multimodal, and editable dance generation, while enabling real-time inference. Different from the diffusion-based model, DanceMosaic follows bidirectional BERT-like modeling, inspired by the single-modality generative masked models, while enabling multimodal motion generation via novel triple-stream conditioned masked transformer, progressive multimodal training, and inference-time motion token optimization.

According to some embodiments of the disclosure, the features used during the training of the machine-learned models and/or transformers used in GenHMR, BioPose, ControlMM, and/or DanceMosaic may be evaluated and one or more of the features with a lesser relative impact on a prediction, estimation, categorization, inference, or the like than other features may be removed as part of a model sparsification process during both training and inference mode to sparsify the machine-learned model. When the machine-learned model and/or transformer comprises a neural network, one or more nodes or paths may be removed based on the elimination of one or more features. Advantageously, sparsification of the machine-learned model and/or transformer may allow the model to execute using less memory and reduced computational requirements.

Advantageously, one or more of the features used in training or during inference mode of the machine-learned models and/or transformers used in GenHMR, BioPose, ControlMM, and/or DanceMosaic may be selected to have different quantization levels, e.g., 64-bit, 32-bit, etc. to reduce the size and complexity of the machine-learned model. For example, the quantization level for representing the various features of an object of an image may be varied based on a level of precision required in generating a prediction, estimation, categorization, inference, or the like.

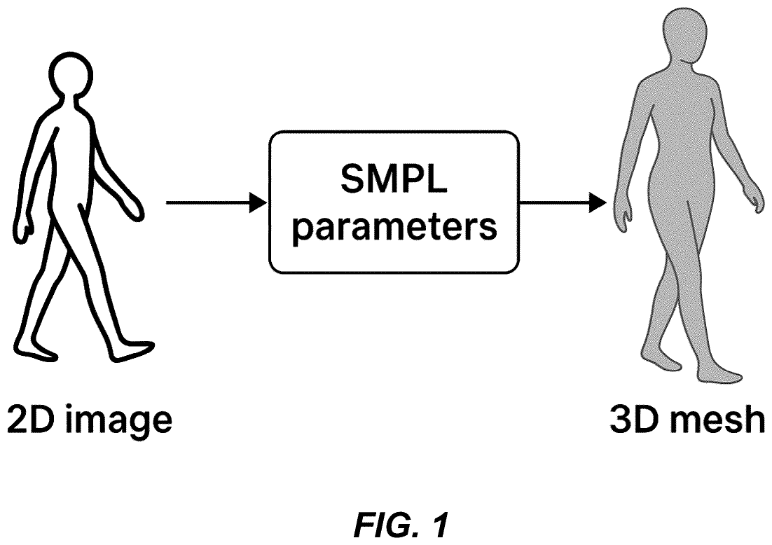

FIG. 1 is a diagram illustrating the creation of a 3D mesh from one or more 2D images using SMPL (Skinned Multi-Person Linear Model) by estimating 3D body pose and shape parameters from 2D visual input. The input is one or more 2D images of a person from which 2D keypoints may be extracted. SMPL uses three parameters for representing the human body: pose parameters (θ), which may represent joint rotations (typically 24 joints, each with three degrees of freedom); shape parameters (β), which correspond to body shape coefficients (typically 10 PCA coefficients); and global translation (t), which represent the overall position in 3D space. The SMPL model outputs a 3D mesh (6890 vertices, 13918 faces) in a canonical skeleton topology.

There are two main approaches for performing the estimation. In optimization based methods, SMPL is fit to the 2D image by minimizing a loss function as follows:

$$L = Lkeypoints + Lpose\_prior + Lshape\_prior + LregL = L\_ \{ \backslash text \{ keypoints \} \} + L\_ \{ \backslash text \{ pose \backslash \_prior \} \} + L\_ \{ \backslash text \{ shape \backslash \_prior \} \} + L\_ \{ \backslash text \{ reg \} \} L = Lkeypoints + Lpose\_prior + Lshape\_prior + Lreg$$

Where:
LkeypointsL_{\text {keypoints}}Lkeypoints: 2D reprojection error between detected 2D keypoints and SMPL joint projections.
Lpose_priorL_{\text {pose\_prior}}Lpose_prior: Encourages realistic joint angles.
Lshape_priorL_{\text {shape\_prior}}Lshape_prior: Keeps body shape plausible.
LregL_{\text {reg}}Lreg: Regularization terms.

Iterative optimization is used to minimize the loss function (e.g., SMPLify, SMPLify-X).

The operations may include detecting 2D joints, initializing the SMPL parameters, optimizing parameters to minimize the reprojection error, and outputting the 3D mesh.

In learning based methods, a neural network is trained to directly predict SMPL parameters from the 2D image. Examples include HMR (Human Mesh Recovery), SPIN, and PARE. Two models may be used in the prediction process: a CNN backbone (e.g., ResNet) is used to extract image features and a regressor is used to predict SMPL parameters (θ,β) (θ, β) (θ,β). Various loss functions may be used include a 2D keypoint reprojection loss, a 3D pose loss (if ground-truth available), and an adversarial loss (to enforce realism).

The operations may include providing an input image to the CNN feature extractor, predicting the SMPL parameters, generate a 3D mesh using SMPL, and project back to 2D to determine the loss.

Thus, an SMPL model may output a 3D mesh, which may include a template deformed by shape and posed via skinning. The model may further include joint positions and camera parameters. Generating a 3D mesh using SMPL may, however, suffer from some drawbacks including ambiguity multiple 3D poses can look the same from a single 2D image, occlusion uncertainty due to body parts being hidden in an image, and evaluating scale and depth, which can be camera model dependent,

Some embodiments of the disclosure are described herein in the context of models based on a transformer architecture. Transformers may be suited for processing sequences of data because they can process any sequence length without fixed-size constraints, which is different than traditional CNNs. Transformers also make use of a mechanism called self-attention, which captures dependencies between elements of the sequence regardless of their distance, whereas RNNs and LSTMs are less efficient at long-range dependencies. Furthermore, unlike RNNs, transformers compute attention for all tokens in parallel improving GPU/TPU efficiency.

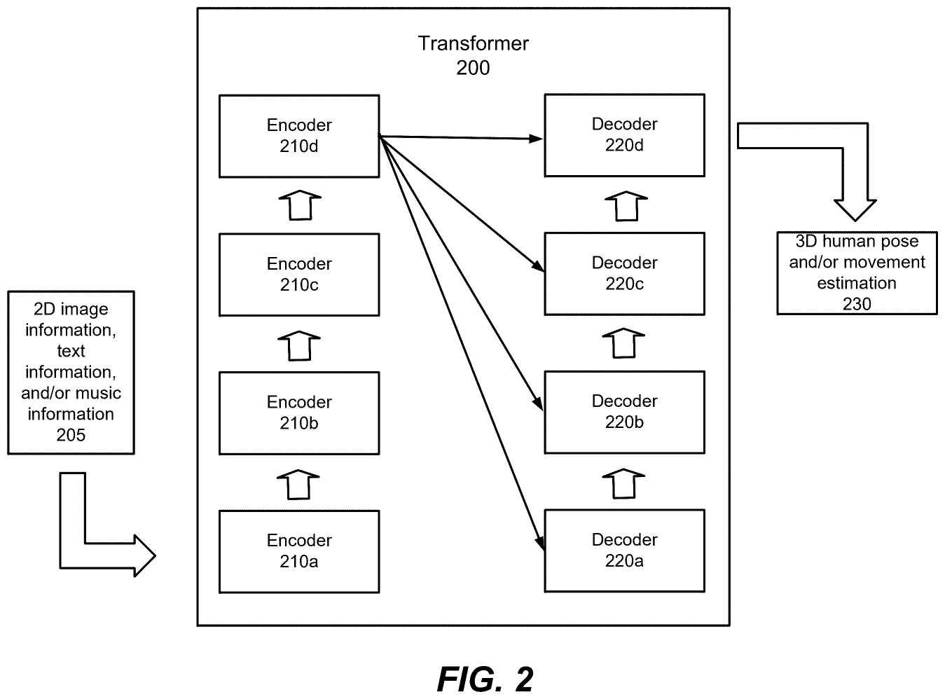

FIG. 2 is a block diagram of a transformer architecture that may be used to process monocular image information, text information, and/or music information to generate 3D human pose and movement estimation information. As described above, the transformer name is based on the ability of the architecture to transform one sequence into another. Moreover, the transformer architecture provides for the ability to process an entire sequence at once as opposed to one step at a time, such as is done in RNNs. This parallelization allows models based on a transformer architecture to be faster to train and operate in inference mode thereby improving the performance of a computer system. As shown in FIG. 2, an encoder stack 210a, . . . , 210d may receive a 2D image information, text information, and/or music information and convert this information into vectors, which represent the semantics and position of the image data, text data, and/or music data. The decoder stack 220a, . . . , 220d may receive this vector embedding of the input information 205 and use them to generate context and produce the 3D human pose and/or movement estimation 230. In some embodiments, both the encoder and decoder include a stack of identical layers 210a, . . . , 210d and 220a, . . . , 220d, respectively, each containing a self-attention mechanism and a feed-forward neural network. The attention mechanism may allow the transformer 200 to focus on specific parts of the input information 205 when making predictions or estimations. Specifically, the transformer may calculate a weight for each element of the input, which indicates the importance of that element for the current prediction or estimation. These weights may then then be used to calculate a weighted sum of the input, which is used to generate the prediction. Self-attention is a specific type of attention mechanism where the transformer 300 focuses on different parts of the input information to make a or estimation. In such embodiments, the transformer 200 looks at the input sequence multiple times while focusing on a different part of the input information, such as a sequence, each time it looks at it. The transformer architecture may allow the self-attention mechanism to be applied multiple times in parallel, which may allow the transformer 200 to learn more complex relationships between the input information 205 and the 3D human pose and/or movement estimation 230.

The transformer 200 may be trained using semi-supervised learning in some embodiments of the disclosure. The transformer 200 may be pre-trained using a large dataset of unlabeled data in an unsupervised training operation. The initial pre-training may allow the transformer 200 to learn general patterns and relationships in the input data and output estimates. A second supervised training operation may then be performed in which the model may be trained using a smaller labeled dataset. This second supervised training operation may improve the performance of the transformer 200 for specific applications.

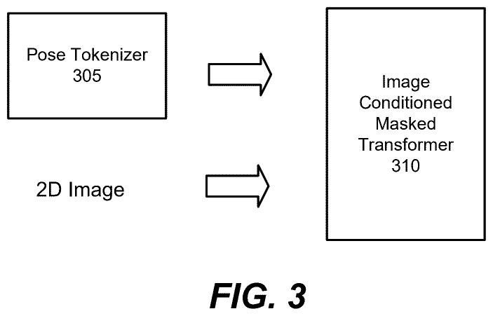

As shown in FIG. 3, Generative Human Mesh Reconstruction (GenHMR) according to some embodiments of the disclosure comprises a pose tokenizer 305 and an image conditional masked transformer 310. The framework follows a two-stage training paradigm. In the first stage, the pose tokenizer 305 is trained using Vector Quantized Variational Autoencoders (VQ-VAE), which converts the continuous human pose or sensor data, such as the rotations of skeletal joints, into a sequence of discrete pose tokens in a latent space, based on a learned codebook.

In the second stage, generative masking training, a portion of the sequence of discrete pose tokens is randomly masked. The image conditional masked transformer 310 is then trained to predict the masked sequence of discrete pose tokens by learning the conditional categorical distribution of each sequence of discrete pose tokens, given the input image and the unmasked sequence of discrete pose tokens. Thus, GenHMR is able to learn through generative masking training, explicit probabilistic mapping from the 2D image to the human pose. Leveraging such a feature, uncertainty guided iterative sampling during inference defines how the model decodes multiple sequences of discrete pose tokens simultaneously in each iteration by sampling from the learned image conditioned pose distributions. The sequence of discrete pose tokens with low prediction uncertainties are kept and the others are re-masked and re-predicted in the next iteration. This feature may allow GenHMR to iteratively reduce 2D-to-3D mapping uncertainties and progressively correct the wrong joint rotations to improve the mesh reconstruction accuracy. To further refine the reconstruction quality, 2D pose-guided refinement directly optimizes the decoded pose tokens in the latent space, with an objective to force the projected 3D body mesh to align with the 2D pose clues.

A goal of the pose tokenizer 305 is to learn a discrete latent space for 3D pose parameters by quantizing the image encoder's output into learned codebook. The VQ-VAE is leveraged to pretrain the pose tokenizer. Specifically, given a parametric human model such as SMPL, the VQ-VAE uses a convolution encoder to map the pose parameters into a latent embedding. Each latent embedding is then quantized by finding the nearest codebook entry based on the Euclidean distance. Then, the total loss function consists of a SMPL reconstruction loss, a latent embedding loss, and a commitment loss. This tokenizer is optimized using a straight-through gradient estimator, with the codebook entries being updated by an exponential moving average and a codebook reset.

The image conditioned masked transformer 310 comprises the image encoder and the masked transformer decoder with multi-scale deformable cross attention. The image encoder uses a vision transformer (ViT) to extract image features. The VIT-H/16 variant processes 16×16 pixel patches through transformer layers to generate feature sequences of discrete pose tokens. A multi-scale feature approach is adopted by up sampling initial feature maps from the image encoder to create a set of feature maps with varying resolutions. High resolution feature maps capture fine-grained visual details (e.g., the presence and rotation of individual joints), while low-resolution feature maps preserve high-level semantics (e.g., the structure of the human skeleton). The imaged masked transformer decoder employs a multi-layer transformer whose inputs are the sequence of discrete pose tokens obtained from the pose tokenizer. This sequence of discrete pose tokens serve as the pose queries that are cross attended to the multiscale feature maps from the image encoder. Because these feature maps are of high resolution, multi-scale deformable cross-attention is adopted to mitigate computational cost. In particular, each sequence of discrete pose tokens is only attended to a small set of sampling points around a reference point on multi-scale feature maps, regardless of the spatial size of the feature maps.

The inference strategy comprises Uncertainty-Guided Sampling, which iteratively samples high confidence pose tokens based on their probabilistic distributions, and 2D Pose-Guided Refinement, which fine-tunes the sampled pose tokens to further minimize 3D reconstruction uncertainty by ensuring consistency between the 3D body mesh and 2D pose estimates.

The sample process begins with a fully masked sequence where all sequences of discrete pose tokens are initially set to be masked. The sequence of discrete pose tokens is decoded over iterations. At each iteration, the masked sequence of discrete pose tokens is decoded by performing stochastic sampling, where the sequence of discrete pose tokens are sampled based on their prediction distributions. After the token sampling, a certain number of the sequences of discrete pose tokens with low prediction confidences are re-masked and re-predicted in the next iteration.

The number of sequences of discrete pose tokens to be re-masked is determined by a masking schedule where a decaying function of the specific iteration that produces higher masking ratio in the early iterations when the prediction confidence is low, while yielding low masking ratio in the latter iterations when the prediction confidence increases as more context information becomes available from previous iterations.

To further reduce uncertainties and ambiguities in the 3D reconstruction, the sequences of discrete pose tokens are refined. This occurs by keeping the whole or at least portions of the pose token network frozen, so that the 3D pose estimates are better aligned with 2D pose clues using 2D pose detectors. This optimization process is initialized by the sequence of discrete pose tokens from uncertainty-guided sampling, and these sequences of discrete pose tokens are then iteratively updated to minimize a composite guidance function that penalizes the misalignment of 3D and 2D poses along with regularization terms. This ensures that the reprojected 3D joints are aligned with the detected 2D key points.

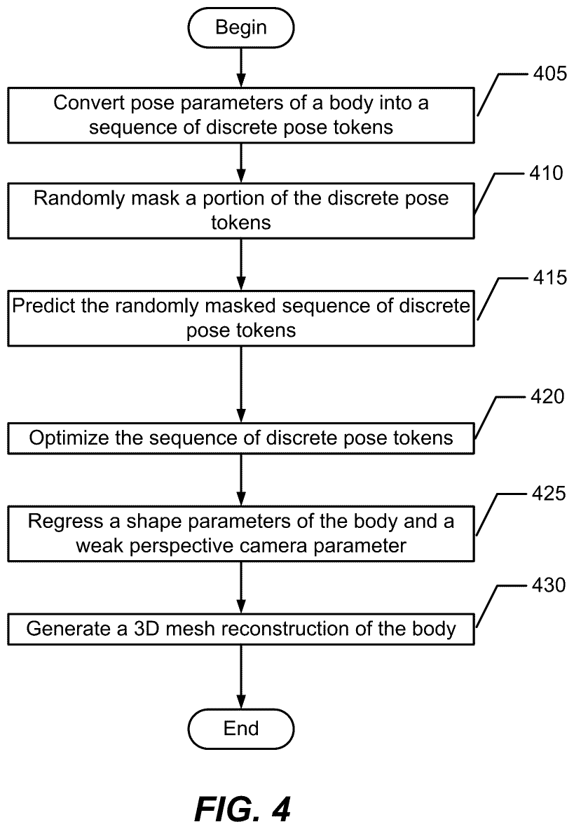

Referring to FIG. 4, according to some embodiments of GenHMR, operations begin at block 405, where the pose tokenizer 305 converts, based on a learned codebook, pose parameters of a body in a sequence of discrete pose tokens. At block 410, a portion of the sequence of discrete pose tokens is randomly masked. The imaged conditioned masked transformer 310 predicts the randomly masked sequence of discrete pose tokens based on multi-scale features extracted from a monocular image by an image conditioned masked transformer at block 415. The sequence of discrete pose tokens is optimized by aligning a re-projected 3D pose with an estimated 2D pose at block 420. A shape parameter of the body and a weak perspective camera parameter are obtained from the multi-scale features through regression at block 425. A 3D mesh reconstruction of the body is generated at block 430 based on the shape parameter and the weak perspective camera parameter.

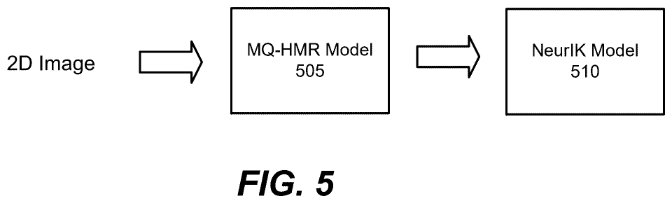

A goal of BioPose is to predict biomechanically accurate 3D human poses directly from monocular videos. As shown in FIG. 5, BioPose may include two core components: The MQ-HMR model 505 uses a multi-query deformable transformer decoder to extract multi-scale image features from vision transformer encoder, enabling precise recovery of 3D human meshes. These meshes are then used by the NeurIK model 510, which treats the mesh vertices as virtual markers, applying a spatial-temporal network to infer biomechanically accurate 3D poses while maintaining anatomical constraints. To further improve accuracy, a 2D-informed pose refinement step may be used to align the 3D predictions with 2D observations, enhancing both visual coherence and biomechanical validity.

Some embodiments of the present disclosure make use of the SMPL model, a differentiable parametric framework for representing human surface geometry. This model encodes the human body using pose parameters θ∈ [symbol] ^{24×3} and shape parameters β∈ [symbol] ¹⁰. The pose parameters θ=[θ₁, . . . , θ₂₄] include both the global orientation θ∈ [symbol] ³ of the entire body and the local joint rotations [θ₂, . . . , θ₂₄]∈ [symbol] ^{3×N}, where N=6890 vertices represent the surface of the body. The positions of the body joints J∈ [symbol] ^{3×k} are derived as a weighted sum of these vertices, formulated as J=MW, where W∈ [symbol] ^{N×k} contains the predefined weights that map vertices to the corresponding joints.

The BSK model, e.g., widely-adopted OpenSim models, is represented by a series of bone segments that are interconnected through movable anatomical joints, which possess anatomical movement constraints, such as Degrees of Freedom, to limit the range of motion of the respective body parts. In particular, the BSK model generally includes 24 rigid bone segments, which are represented by three sets of parameters (q^{o}, q^{r}, s). The anatomical joint orientation

$${q}^{o} ∈ [ {q}_{1}^{o} , … , {q}_{24}^{o} ]$$

with

$${q}_{1}^{o}$$

∈ [symbol] ³ defining the relative orientation of each joint with respect to its parent joint along the kinematic skeleton tree. Therefore, q^{o} are determined by the anatomical structure of the human skeleton.

$${q}^{r} ∈ [ {q}_{1}^{r} , … , {q}_{24}^{r} ]$$

represents the motion-induced joint rotation with

$${q}_{1}^{r}$$

∈ [symbol] ^{D}^{ᵢ} and Dᵢ≤3 representing the Euler's angle rotation of joint i relative to its parent in the kinematic tree under the constraints imposed by the degree of freedom Dᵢ of each joint i. The bone scale s∈[s₁, . . . , s₂₄] with sᵢ∈ [symbol] ³ aims to tailer the generic anatomical skeleton model (in the rest pose) by scaling each bone length and shape along with the (x, y, z) axis. The scaled skeleton yields the body joints P_{J}∈ [symbol] ^{3×24} at anatomical positions.

With assistance of the BSK model, the kinematic analysis aims to find the optimal pose, i.e., joint rotation angles q^{r}, which can best fit the BSK model to the motion capture sequences. Towards this goal, a set of model markers is first attached to the bone segments in such a way that each bone segment is associated with at least Dᵢ markers to ensure the unique solutions of the derived rotation angles at joint i with Dᵢ degrees of freedom. Then, a set of corresponding experiential markers is placed on the human subject. Then, the pose q^{r} and bone scale s can be obtained by solving an optimization problem that reduces or minimizes the distance between each experimental marker and its corresponding model marker. i.e.,

$${q}^{r *} , {s}^{*} = arg {min}_{{q}^{r} , s} {\sum }_{i = 1}^{M} ‖ {f}_{FK} ( {q}^{r} , s , {q}^{o} , {p}_{i} ) - {x}_{i}^{exp} ‖$$

where M is the number of markers, Pᵢ∈ [symbol] ³ denotes the position of i-th model marker in the local coordination system of the body segment to which it is attached. f_{FK}(q^{r}, s, q^{o}, pᵢ) is the forward kinematics transformation that converts the model marker i from its local coordinate frame to the world coordination system under the scaled skeleton with the pose of

$${q}^{r} \cdot {x}_{i}^{exp} ∈ {ℝ}^{3}$$

is the position of the experiential marker i in the world coordination system. We leverage OpenSim, the classic biomechanical optimizer, and BML-MoVi dataset to obtain q^{r}*, s*, which serve as the ground-truth data to train the NeurIK model 510. A goal of MQ-HMR is predicting accurate virtual experiential markers,

$${x}_{VM}^{exp} ,$$

from the 3D mesh, which serves as the inputs for NeurIK model 510. Towards this goal, the MQ-HMR model 505 may include two components: the image encoder and the multi-query deformable transformer decoder.

The image encoder is based on the Vision Transformer (ViT), specifically the VIT-H/16 variant. The encoder begins by dividing the input image into 16×16 pixel patches, which are processed through multiple transformer layers to produce a set of feature tokens that encode the visual information. To enhance this process, a multi-scale feature extraction approach is used. After generating the initial feature map, the encoder upsamples it to produce feature maps at various resolutions. These higher-resolution maps capture fine-grained visual details, such as joint positions and orientations, while lower-resolution maps preserve broader, high-level semantic information, such as the overall human skeleton structure. This multi-scale strategy allows the encoder to capture both intricate local details and global contextual information simultaneously, which is desirable for accurate pose estimation.

Building upon multi-scale feature maps, the multi-query deformable transformer decoder introduces a mechanism designed to recover precise 3D human poses by extracting fine-grained semantic information from diverse resolutions. The multi-query approach initializes multiple pose queries as zero pose tokens, which interact with the encoder's multi-scale feature maps. These queries generate pose anchors crucial for accurately estimating complex human poses, especially in challenging scenarios like occlusions or ambiguous body positions. To process high resolution feature maps efficiently, MQ-HMR incorporates a multi-scale deformable cross-attention mechanism, focusing each query on a small set of sampling points near the pose anchors and dynamically adjusting attention to the most relevant regions. This optimizes or improves both computational efficiency and accuracy, allowing the model to concentrate on relevant spatial features with reduced or minimal overhead. The deformable attention mechanism (DAM) for multi-scale features is formulated as:

$$DAM ( Q , {\hat{r}}_{k} , {\{ {F}^{\text{?}} \}}_{s = 1}^{S} ) = {\sum }_{s = 1}^{S} {\sum }_{m = 1}^{M} {α}_{ksm} \cdot {WK}^{\text{?}} ( {\hat{r}}_{k} , Δ {r}_{ksm} )$$

$$\text{?} \text{indicates text missing or illegible when filed}$$

Q represents the pose token queries, \hat{r}ₖ denotes the learnable reference points, refers to the learnable reference points, Δrₖₛₘ refers to the learnable sampling offsets around the reference points,

$${\{ {F}^{s} \}}_{s = 1}^{S}$$

are the multi-scale image features, αₖₛₘ are the attention weights, and W is a learnable weight matrix, This deformable cross-attention strategy allows the model to capture fine-grained details while balancing computational efficiency. From this accurately reconstructed 3D mesh, virtual markers

$${X}_{VM}^{exp}$$

are extracted, serving as input to the NeurIK module for further refinement and achieving precise biomechanical accuracy.

In line with established practices in HMR research, we train our MQ-HMR model using a combination of losses based on SMPL parameters, 3D keypoints, and 2D keypoints. The final overall loss is:

$${L}_{total} = {L}_{smpl} + {L}_{3 D} + {L}_{2 D}$$

where Lₛₘₚₗ reduces or minimizes the error between the predicted and ground-truth SMPL pose (θ) and shape (β) parameters, L_{3D} supervises the accuracy of the 3D keypoint predictions, and L_{2D} enforces consistency between the projected 3D keypoints and their corresponding 2D annotations.

After extracting virtual markers

$${X}_{VM}^{exp}$$

from MQ-HMR, the NuerIK model 510 processes these markers to predict biomechanically accurate 3D poses q^{r} and bone scale s. To achieve this, the NeurIK model 510 may use three components: i) a Spatial Convolution Encoder to model spatial relationships among body parts, ii) a Temporal Transformer Encoder to capture dynamic motion patterns over time, and iii) multiple loss functions that incorporate biomechanical constraints from a musculoskeletal model.

The Spatial Convolution Encoder is designed to extract high-dimensional spatial features from a single frame. Given the 3D human mesh generated by the pre-trained MQ-HMR model, M virtual markers are extracted from the mesh, where each marker m has 3D coordinates (xₘ, yₘ, zₘ). These marker positions

$${X}_{VM}^{exp} ∈ {ℝ}^{M \times 3}$$

are first projected into a higher-dimensional space using a trainable linear projection, resulting in the spatial embedding Zₙ_{ᵢ}∈ [symbol] ^{M×c}, where c is the spatial embedding dimension. To capture spatial relationships across the body, this spatial embedding is processed through a series of 1-D convolutional layers, which capture both local relationships between neighboring markers and global dependencies across the entire body structure. The output of this spatial convolution process for frame nᵢ, Zₙ_{ᵢ}∈ [symbol] ^{M×c} represents a refined spatial feature embedding, which is passed to the Temporal Transformer Encoder for temporal modeling.

After encoding high dimensional spatial features for each individual frame, the Temporal Transformer Encoder models the dependencies across the sequence of frames. For frame nᵢ, the spatially encoded feature matrix Zₙ_{ᵢ}∈ [symbol] ^{M×c} is flattened into a vector zₙ_{ᵢ}∈ [symbol] ^{1×(M·c)}. These vectors are concatenated across all n frames to form the sequence matrix Z_{seq}∈ [symbol] ^{n×(M·c)}, which represents the spatial features for the entire motion sequence. To capture temporal relationships, a learnable temporal positional embedding PEₙ∈ [symbol] ^{n×(M·c)} is added to the sequence matrix. The temporal transformer then applies multi-head self-attention blocks and feed-forward layers to model both short-term and long-term dependencies across frames. This allows the model to understand the progression of motion and how body parts evolve over time. The final output of the temporal transformer, Yₙ∈ [symbol] ^{n×(M·c)} is used to predict key biomechanical parameters, such as body scales s and joint angles q^{r}. These predictions are further refined through a Forward Kinematics (FK) module to ensure biomechanically accurate marker and joint positions.

Spatial and temporal models are trained using multiple supervisions, including joint positions, marker positions, body scales, and joint angles. The joint positions correspond to anatomical landmarks in the musculoskeletal model, ensuring biomechanical accuracy. The overall loss function L is a weighted sum of four terms: Lⱼ for joint positions, Lₘ for marker positions, Lₛ for body scales, and L_{q} for joint angles. These terms are weighted by coefficients λⱼ, λₘ, λₛ, and λ_{q}, respectively, to control their contributions to the total loss. The overall loss function is defined as

$${L}_{neurIK} = {λ}_{j} {L}_{j} + {λ}_{m} {L}_{m} + {λ}_{s} {L}_{s} + {λ}_{q} {L}_{q}$$

In particular, both Lⱼ and Lₘ incorporate biomechanical constraints during training through the forward kinematics (FK) layer. As shown in FIG. 3, the FK layer transforms the rest-pose BSK model markers and anatomical joints to the new positions according to the estimated rotation angles qᵣ in such a way that the model markers best match the virtual experimental markers. Since a full-body skeletal model from OpenSim may be used, the FK transformation is inherently constrained by the realistic degrees of freedom and range of motions of body joints.

During inference time, to further reduce uncertainties in the 3D reconstruction process, the pose query tokens Q may be fine tuned within the MQ-HMR model 505 while keeping the rest of the network frozen.

This refinement ensures alignment between the predicted 3D poses and 2D pose data, leveraging robust 2D pose detectors such as OpenPose. The process begins with the pose query tokens generated by MQ-HMR, and the initial pose parameters θ′ are derived from the output of MQ-HMR for a given input image. These tokens and parameters are iteratively adjusted to reduce or minimize discrepancies between the inferred 3D and observed 2D poses by optimizing a guidance function F (Qₜ, J_{2D}, θ). This function penalizes misalignments between the two pose domains while enforcing regularization through the following expression:

$${Q}^{+} = arg {min}_{{Q}_{t}} ( {ℒ}_{2 D Refine} ( {J}_{3 D}^{′} ) + {λ}_{{θ}^{′}} {ℒ}_{{θ}^{′}} ( {θ}^{′} ) )$$

where the term [symbol] _{2DRefine} (J′_{3D}) aims to align the reprojected 3D joints (J′3) with the detected 2D keypoints (J_{2D}), using the following relation:

$${ℒ}_{2 D Refine} ( {J}_{3 D}^{′} ) = {\vert II ( K ( {J}_{3 D}^{′} ) ) - {J}_{2 D} \vert}^{2}$$

where II (K(⋅)) represents the perspective projection function governed by the camera intrinsics K. Simultaneously, the regularization term [symbol] _{θ′}(θ′) constrains the pose parameters θ′, ensuring that they do not diverge excessively from their initial values, thereby avoiding anatomically implausible body configurations. The pose tokens Qₜ are iteratively updated at each step t via gradient-based optimization as follows:

$${Q}_{t + 1} = {Q}_{t} - η {∇}_{{Q}_{t}} F ( {Q}_{t} , {J}_{2 D} , {θ}^{′} )$$

where η determines the step size for the update, and ∇_{Q}_{ₜ}F(Qₜ, J_{2D}, θ) denotes the gradient of the objective function with respect to the pose tokens at the current iteration t. This iterative refinement process, carried out over T total iterations, gradually fine-tunes the pose representation, reducing the gap between the 3D estimates and their 2D counterparts while keeping realistic pose configurations.

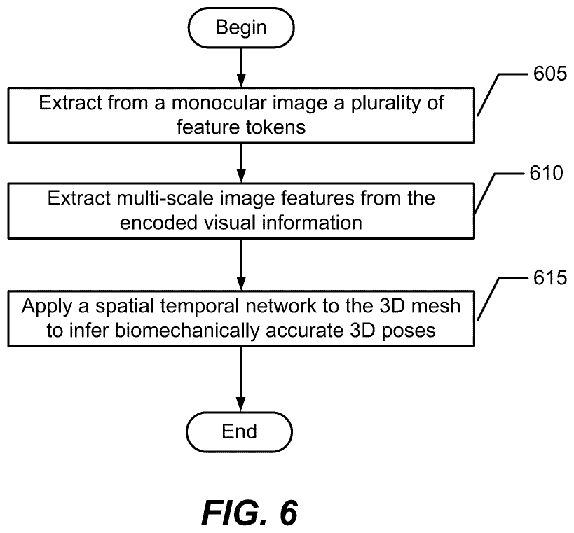

Referring to FIG. 6, according to some embodiments of BioPose, operations begin at block 605, where the vision transformer encoder extracts a plurality of feature tokens from a monocular image. At block 610, a multi-query deformable transformer decoder is used to extract multi-scale image features from the encoded visual information to generate a 3D mesh reconstruction of a body. A spatial-temporal network is applied to the 3D mesh at block 615 to infer biomechanically accurate 3D poses of the body.

An objective of ControlMM, according to some embodiments of the disclosure, is to enable controllable text-to-motion generation based on a masked motion model that simultaneously delivers high precision, high speed, and high fidelity. In particular, given a text prompt and an additional spatial control signal, a physically plausible human motion sequence may be generated that closely aligns with the textual descriptions, while following the spatial control conditions, i.e., (x, y, z) positions of each human joint at each frame in the motion sequence. In the following description, the background of conditional motion synthesis based on the generative masked motion model is described. Two components of ControlMM, including masked consistency training and inference-time logits editing are then described. The first component aims to learn the categorical distribution of motion tokens, conditioned on spatial control during training time. The second component aims to improve control precision by optimally modifying learned motion distribution via logits editing during inference time.

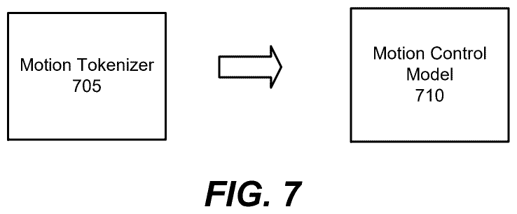

FIG. 7 illustrates a Pretrained Motion Tokenizer 705 from a masked motion model and a Motion Control Model 710. During the training phase of ControlMM, the pretrained Encoder, Decoder and Conditioned Masked Transformer are frozen, only the Motion Control Model 710 is trained.

An objective of the Motion Tokenizer 705 is to learn a discrete representation of motion by quantizing the encoder's output embedding z into a codebook C. For a given motion sequence X=[xi, x2, . . . , Xr], where each frame x represents a 3D pose, the encoder compresses X into a latent embedding z E IR{txd with a downsampling rate of T ft. The embedding z is quantized into codes c EC from the codebook C={yk}f=i, which contains K codes. The nearest code is selected by minimizing the Euclidean distance between z and the codebook entries, computed as ii=argminj llz−Cj 1 (The vector quantization loss LvQ is defined as:

$${L}_{VQ} = {‖ sg ( z ) - e ‖}_{2}^{2} + β {‖ z - sg ( e ) ‖}_{2}^{2}$$

where sg(⋅) is the stop-gradient operator and B is a hyper-parameter for commitment loss.

During the second stage, the quantized motion token sequence X is updated with [MASK] tokens to form the corrupted motion sequence XM. This corrupted sequence along with text embedding W are fed into a text-conditioned masked transformer parameterized by 0 to reconstruct input motion token sequence with reconstruction probability equal to p0 (xi I Xw W). The objective is to minimize the negative log-likelihood of the predicted masked tokens conditioned on text:

$${ℒ}_{mask} = - {𝔼}_{X ∈ 𝒟} [ {\sum }_{∀ i ∈ [ 1 , L ]} log p ( {x}_{i} \vert {X}_{\overline{M}} , W ) ]$$

During inference, the transformer masks out the tokens with the least confidence and predicts them in parallel in the subsequent iteration. The number of masked tokens nM is controlled by a masking schedule, a decaying function of the iteration t. Early iterations use a large masking ratio due to high uncertainty, and as the process continues, the ratio decreases as more context is available from previous predictions.

ControlMM aims to generate a human motion sequence based on the text prompt (W) and spatial control signal(S) according to some embodiments of the disclosure. Towards this goal, a masked consistency modelling approach is introduced, which aims to learn the motion token distribution jointly conditioned on W and S by exploiting conditional token masking with consistency feedback according to some embodiments of the disclosure.

According to some embodiments of the disclosure, a masked transformer architecture is used to learn the conditional motion token distribution. This is the first attempt to incorporate the ControlNet design principle from diffusion models into generative masked models, such as BERT-like models for image, video, language, and motion generation. According to some embodiments, the architecture consists of a pre-trained text conditioned masked motion model and a motion control model. The pre-trained model provides a strong motion prior based on text prompts, while the motion control model introduces additional spatial control signals. Specifically, the motion control model is a trainable replica of the pre-trained masked motion model. Each Transformer layer in the original model is paired with a corresponding layer in the trainable copy, connected via a zero-initialized linear layer. This initialization ensures that the layers have no effect at the start of training. Unlike the original masked motion model, the motion control model incorporates two conditions: the text prompt W from the pre-trained CLIP model and the spatial control signal S. The text prompt W influences the motion tokens through attention, while the spatial signal S is directly added to the motion token sequence via a projection layer.

The conditioned masked transformer is trained to learn the conditional distribution p0 (xi I XM, W, S) by reconstructing the masked motion tokens, conditioned on the unmasked tokens X fvi, text prompt (W), and spatial control signal (S). The spatial control condition is a sequence of joint control signals 5=[si, s2, . . . , Sr] with si E IR{22×3. Each control signal si specifies the targeted 3 D coordinates of the joints to be controlled, among the total 22 joints, while joints that are not controlled are zeroed out. Because the semantics of the generated motion are primarily influenced by the textual description, to ensure the controllability of spatial signals, the spatial control signals are extracted from the generated motion sequence and directly optimize the consistency loss between input control signals and those extracted from the output. This consistency training not only enhances controllability but also addresses a unique challenge in controllable motion generation. In the image domain, spatial control signals can be directly applied, and uncontrolled regions are simply zeroed out. However, for motion control, zero-valued 3D joint coordinates may either indicate that a joint should be controlled, with its target position at the origin in Euclidean space, or that the joint is uncontrolled. Consistency training explicitly guides the model on which joints are controlled and which are not, effectively resolving this ambiguity.

While consistency training may offer significant benefits, integrating consistency loss into the training of generative masked models may present a challenge: the need to convert motion tokens in the latent space into motion representations in Euclidean space. This conversion uses sampling from the categorical distribution of motion tokens during training, a process that is inherently non-differentiable. To address this, the straight-through Gumbel-Softmax technique may be used. This approach performs categorical sampling during the forward pass and approximates the categorical distribution with differentiable sampling using the continuous Gumbel-Softmax distribution during the backward pass, i.e.,

$${p}_{θ} ( {x}_{i} \vert {X}_{\overline{M}} , W , S ) = \frac{exp ( \frac{( {ℓ}_{i} + {g}_{1} )}{τ} )}{{\sum }_{j = 1}^{k} exp ( \frac{{ℓ}_{j}}{τ} )}$$

where r refers to temperature and g represents Gumbel noise with Bv . . . , Bk being independent and identically distributed (i.i.d.) samples from a Gumbel(0,1) distribution. The Gumbel(0,1) distribution can be sampled via inverse transform sampling by first drawing u˜Uniform(0,1) and then computing g=−log (−log (u)).

With the help of the training-time differential sampling, the consistency loss may be defined, which assesses how closely the joint control signal extracted motion the generated motion aligns with the input spatial control signal s:

$${L}_{s} ( {e}_{c} , s ) = \frac{{\sum }_{n} {\sum }_{j} {σ}_{nj} ⊙ ‖ {s}_{nj} - R ( D ( {e}_{c} ) ) ‖}{{\sum }_{n} {\sum }_{j} {σ}_{nj}}$$

where CJnj is a binary value indicating whether the spatial control signal s contains a control value at frame n for joint j. The motion tokenizer decoder D (⋅) converts motion embedding into relative position in local coordinate system and R(⋅) further transforms the joint's local positions to global absolute locations. ec are the entry embeddings of the codebook and c are the entry indices that are sampled from the motion distribution p0 (c I Xw W, S). The global location of the pelvis at a specific frame can be calculated from the cumulative aggregation of rotations and translations from all previous frames. The locations of the other joints can also be computed by the aggregation of the relative positions of the other joints to the pelvis position. The final loss for masked consistency training is the weighted combination masked training loss and motion consistency loss:

$$ℒ = {αℒ}_{mask} + ( 1 - α ) {L}_{s} ( {e}_{c} , s )$$

To achieve more accurate and generalizable spatial control, the logits of the motion token classifier may be directly optimized along with the motion codebook, while keeping the rest of the network frozen. The goal is to enhance control precision by further reducing the discrepancy between the generated motion and the desired control objectives. This approach does not require pretraining on specific spatial control signals, allowing the model to handle arbitrary, out-of-distribution spatial signals during inference, enabling new control tasks such as obstacle avoidance in a zero-shot manner.

Logit editing, according to some embodiments of the disclosure, may be used to update the learned logits through gradient-guided optimization during inference, allowing manipulation of the conditional motion distribution. This ensures that the generated motion, sampled from the adjusted distribution, aligns closely with the input control signals. The optimization process is initialized with the logits obtained from masked consistency training, and these logits are iteratively updated to minimize the consistency loss.

$${l}^{+} = arg {min}_{\text{?}} ( {L}_{s} ( {e}_{c} , s ) )$$

$$\text{?} \text{indicates text missing or illegible when filed}$$

At each iteration i, the logits li are updated using the following gradient-based approach:

$${l}_{\text{?} + 1} = {l}_{\text{?}} - η {∇}_{{l}_{\text{?}}} {L}_{s} ( {l}_{i} , s )$$

$$\text{?} \text{indicates text missing or illegible when filed}$$

where n controls the magnitude of the updates to the logits, while Ls (li, s) represents the gradient of the objective function with respect to the logits 1 at iteration p. This refinement process continues over P iterations. Similarly, the entries in motion codebook may also be edited to minimize the consistency loss:

$${e}_{c}^{i + 1} = {e}_{c}^{l} - η {∇}_{{e}_{c}^{\text{?}}} {L}_{s} ( {e}_{c}^{\text{?}} , s ) ,$$

$$\text{?} \text{indicates text missing or illegible when filed}$$

where ec represents the embedding in the codebook space. Experiments have demonstrated that combining joint logits and codebook editing results in the best performance.

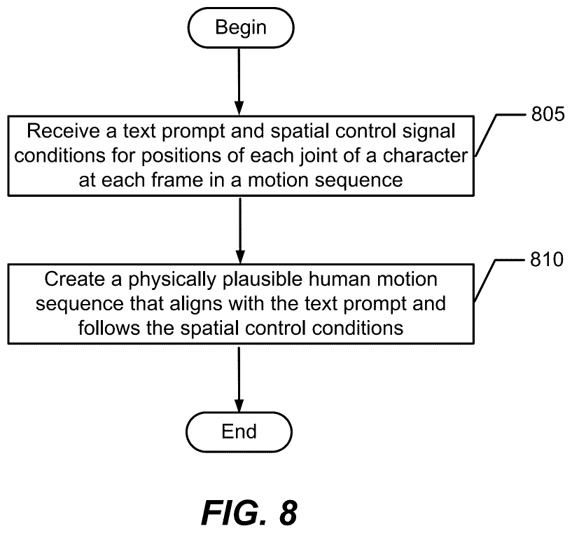

Referring to FIG. 8, according to some embodiments of ControlMM, operations begin at block 805, where a text prompt and a spatial control signal are received indicating spatial control conditions for positions of each joint of a character at each frame in a motion sequence. At block 810, a physically plausible human motion sequence is created using a generative masked motion model that aligns with the text prompt and follows the spatial control conditions.

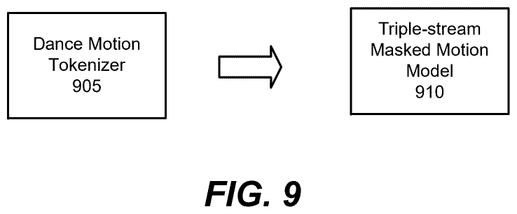

An objective of DanceMosaic according to some embodiments of the disclosure, is to enable controllable, high-fidelity multimodal dance generation through a hierarchical masked motion model. This approach may, in some embodiments, ensure precise beat synchronization, fine-grained motion control, and real-time efficiency. Given an input music signal A, a text prompt T, and optional user constraints on specific joints or body parts, a physically plausible 3D dance sequence that rhythmically aligns with the music while maintaining spatial coherence may be generated. To achieve this, referring to FIG. 9, a dance motion tokenizer 905 may be used, which converts continuous dance motion into discrete motion tokens, providing a structured representation that enhances motion learning. A triple-stream masked motion model 910 may be used, which consists of three masked transformers trained to generate dance sequences conditioned on music, text, and pose control signals. Each transformer learns the probabilistic mapping from its respective control signal to motion tokens, enabling DanceMosaic to produce diverse and adaptable dance choreography. Inference-time optimization may be used to refine motion tokens during inference to improve rhythm synchronization and motion control precision, ensuring smooth and coherent alignment with multimodal inputs.

A goal of the dance tokenizer 905, according to some embodiments, is to encode continuous dance motion into a structured discrete form. Given a dance motion sequence P=[p1, p2, . . . , pN], where each frame pi∈RD represents a 3D skeletal pose, the encoder compresses it into a latent representation h∈Rn×d with a downsampling factor of N/n. The latent features h are then quantized into discrete tokens vk from a learned codebook D={ηl}lK=1, consisting of K unique codebooks. The best-matching code is determined by minimizing the Euclidean distance. The quantization process is trained using the following loss function:

$${ℒ}_{DVQ} = {‖ P - {P}^{\text{?}} ‖}_{1} + α {\sum }_{k = 1}^{K} {‖ sg ( {t}_{k} ) - {\text{?}}_{k} ‖}_{2}^{2} \text{?}$$

$$\text{?} \text{indicates text missing or illegible when filed}$$

where P\hat{ } is the reconstructed motion sequence, tk is the residual at the k-th quantization step, and sg(⋅) represents the stop-gradient operation, which prevents gradient updates through the quantized variables, stabilizing codebook learning.

To enable dance generation conditioned on multiple signals: a music control signal A, a text prompt T and pose control guidance P, a triple-stream masked motion model 910 may be used, which integrates three parallel conditioned masked transformers, including TGM, MGM and PGM, jointly optimized via a multimodal progressive training strategy according to some embodiments,

The Text-Guided Masked Motion Model (TGM) uses a standard multilayer transformer, whose inputs are the concatenation of the motion tokens x1: t from the tokenizer with t as the sequence length, and the embedding x0 from the pre-trained CLIP model. Due to the nature of self-attention in transformers, all motion tokens are learned in relation to the text embedding. Given the discrete dance token sequence V=[v1, v2, . . . , vK], a subset of tokens is masked, forming a corrupted sequence VM. This sequence, along with a textual conditioning signal T, is processed by a text-conditioned masked motion transformer to recover the original dance motion. The model is trained to maximize the likelihood of correctly predicting masked tokens:

$${ℒ}_{TGM}^{mask} = - {𝔼}_{V ∈ 𝒟} {\sum }_{k ∈ Ω} log {p}_{θ} ( {\text{?}}_{k} \vert {V}_{M} , T ) ,$$

$$\text{?} \text{indicates text missing or illegible when filed}$$

where Ω denotes the set of masked indices. During inference, tokens with the least confidence are iteratively masked and re-predicted in subsequent iterations. A decaying masking schedule progressively reduces the uncertainty, improving dance motion coherence and reconstruction quality.

The Music-Guided Motion Model (MGM), according to some embodiments of the disclosure, aims to generate dance motion sequences conditioned on both a music control signal A and a text prompt T. It builds upon the pre-trained text-conditioned masked motion model, which offers a strong generative motion prior based on text inputs. To introduce rhythmic music control, the text-conditioned transformer is extended by integrating it with a parallel trainable music-guided model.

The music-guided model is structured as a trainable copy of the original text-conditioned transformer, where each self-attention layer in the music-guided model is paired with a corresponding layer in the original text-to-motion model, connected via a zero-initialized linear layer. The zero-initialization can prevent interference of the learned text-conditioned motion distribution on learning the music-to-dance mapping at the start of training. The music-guided model is trained to recover the masked motion tokens, conditioned on the text prompt T and the music control signal A. by optimizing the masked token reconstruction objective:

$${ℒ}_{MGM}^{mask} = - {𝔼}_{𝒳 ∈ 𝒟} {\sum }_{k ∈ Ω} log {p}_{θ} ( {\text{?}}_{\text{?}} \vert {V}_{M} \text{?} T , A ) \text{?}$$

$$\text{?} \text{indicates text missing or illegible when filed}$$

where Ω represents the masked indices. The motion token sequence VM of music-guided model shares the same weights and randomly masked patterns as the motion sequence of the text-guided model. The text prompt is self-attended to the motion tokens. The music embedding information, provided by a frozen Jukebox model, is directly added to the motion token sequence via a projection layer. Such design enables high-fidelity dual-modality dance motion generation, while realizing precise alignment between dance rhythms and music beats.

To improve the naturalness of the movements, the Cross Entropy LossLmaMGMsk in the latent space may be supplemented with additional loss components in Euclidean space. The predicted joint positions are computed using forward kinematics, and then their joint velocity and joint acceleration are obtained. To minimize unrealistic sliding of the feet during motion synthesis, a foot velocity loss Lfoot is also incorporated. The total loss function is the weighted sum of the cross entropy LmaMGMsk, joints position loss Lpos, velocity loss Lvel, acceleration loss in Lacc, and foot loss Lfoot.

The Pose-Guided Motion Model (PGM), according to some embodiments of the disclosure, extends MGM by introducing selective dance motion editing, enabling precise control over specific joints or body regions while preserving overall coherence. Using the same or a similar masked transformer architecture as MGM, PGM incorporates spatial constraints into the masked token reconstruction process, allowing targeted modifications to upper-body, lower-body, or joint-specific movements. By leveraging conditional masking and localized refinement, PGM ensures that motion edits remain structurally consistent and physically plausible. In particular PGM is trained to learn the condition motion distribution pθ vi|VM, T, S y recovering the corrupted motion tokens, conditioned on text prompt T, and pose control signal P.

$${ℒ}_{PGM}^{mask} = - {𝔼}_{\text{?} ∈ 𝒟} {\sum }_{k ∈ Ω} log {p}_{θ} ( {\text{?}}_{\text{?}} \vert {V}_{M} , T , P ) ,$$

$$\text{?} \text{indicates text missing or illegible when filed}$$

where Ω represents the masked indices. The pose condition P is a sequence of 3D joints among the total 22 human skeleton joints, which remains unchanged, while the rest of joints are the one that need to be edited. Although that PGM is not trained on music control signal A, integrating PGM and MGM with TGM allows both pose P and music A signals to manipulate the motion prior distribution yielded from TGM. This enables the multimodal dance motion generation. This strategy not only effectively mitigates the training complexity, but also forces the model to attend to be sparse pose control signals, which have less influence on the motion distribution, compared with textual and music clues. To further improve the influence of pose signals, we extract the pose control signals from the generated dance sequence and minimize the consistency loss between input pose signals and those extracted from the output, i.e.,

$${ℒ}_{PGM}^{con} = {\sum }_{k = 1}^{\text{?}} {\sum }_{j ∈ P} {‖ {X}_{gen , j}^{( k )} - {X}_{user , j}^{( k )} ‖}_{2}^{2} \text{?}$$

$$\text{?} \text{indicates text missing or illegible when filed}$$

where P is the set of user-defined non-editable joints, and X (genk), j is the corresponding joint positions extracted from generated motion sequence at frame k.

The joint incorporation of music, text and pose modalities into dance generation model may be challenging because of the conflicting loss function that induces the competing gradients during model training. For example, the joint reconstruction loss of MGM models aims to recover full-body skeleton joints, while the consistency loss of PGM aims to recover only the non-editable joints. To address this challenge, a multimodal progressive training strategy may be used, which incrementally adds modality-specific signals into the model training. In particular, TGM is first trained via text-to-motion dataset, only using the text prompt. Then, PGM is trained with the frozen TGM on the dance motion dataset with the music and text prompts. Finally, PGM is trained with the frozen TGM with pose and text prompts. During the progressive training, motion tokens are converted in the latent space into the Euclidean space because the triple-stream generative models 910 are trained with losses in both spaces. This conversion requires sampling the categorical distribution of motion tokens during training, which is non-differentiable. To address this challenge, a straight-through Gumbel-Softmax strategy may be used to make the token sampling process differentiable by approximating discrete categorical distribution with continuous a Gumbel-Softmax distribution.

The inference strategy, according to some embodiments of the disclosure, comprises two key stages: (1) Confidence-Guided Sampling, which is used for Music-Guided Motion Model (MGM) to ensure a fair comparison with SOTA methods, and (2) Inference-Time Motion Token Optimization, which enables multimodal guidance for dance motion refinement by incorporating pose constraints alongside the music control signal.

Confidence-Guided Sampling in MGM iteratively generates motion tokens from learned probabilistic distributions. Beginning with a fully masked sequence VM of length L, tokens are decoded over n iterations, where masked tokens vk are sampled from pθ (vk|VM, T, A), conditioned on text T and music A. Low-confidence tokens are remasked and resampled using a cosine decay schedule nM=L cos π2 t, prioritizing confident predictions early while refining uncertain ones later.

To enhance motion quality and enforce dance motion alignment with multimodal guidance, motion token representations may be refined by incorporating music A and pose P control signals. Motion embeddings are fine-tuned via gradient descent to minimize the alignment loss:

$${l}^{+} = arg {min}_{\text{?}} L ( {e}_{c} , A , P ) + {ℒ}_{PGM}^{con} , {ℒ}_{PGM}^{con} = {\sum }_{k = 1}^{\text{?}} {\sum }_{j ∈ P} {‖ {X}_{gen , j}^{( k )} - {X}_{user , j}^{( k )} ‖}_{2}^{2} ,$$

$$\text{?} \text{indicates text missing or illegible when filed}$$

where Lₛ (ec, s) ensures consistency between the motion embedding ec and control signals s, and LcoPGMn enforces pose alignment by minimizing the deviation of user-defined non-editable joints P between generated and reference poses. The optimization follows two operations: (1) Confidence-Based Masking to identify and refine uncertain tokens and (2) Gradient-Based Fine-Tuning, where motion tokens are iteratively updated as li+1=li−η∇li (Ls (li, s)+λLcoPGMn), ensuring coherence across multimodal conditions. By integrating Confidence-Guided Sampling with inference-time optimization, according to some embodiments of the disclosure, motion sequences are refined for rhythmically and structurally consistent dance generation.

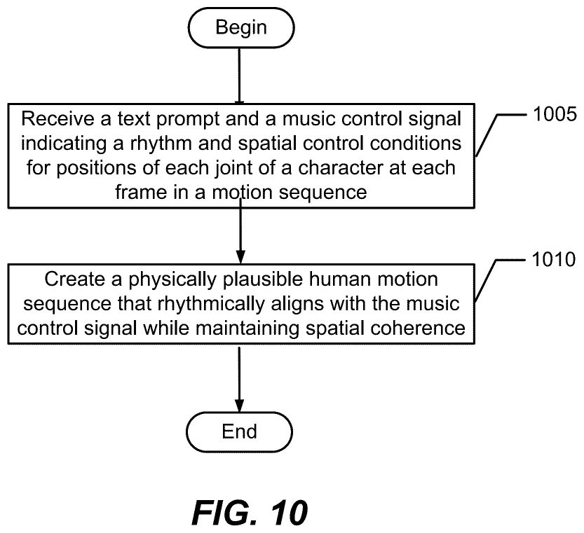

Referring to FIG. 10, according to some embodiments of DanceMosaic, operations begin at block 1005, where a text prompt and a music control signal are received indicating a rhythm and spatial control conditions for positions of each joint of a character at each frame in a motion sequence. A physically plausible human motion sequence is created at block 1010 using a triple-stream masked motion model that rhythmically aligns with the music control signal while maintaining spatial coherence.

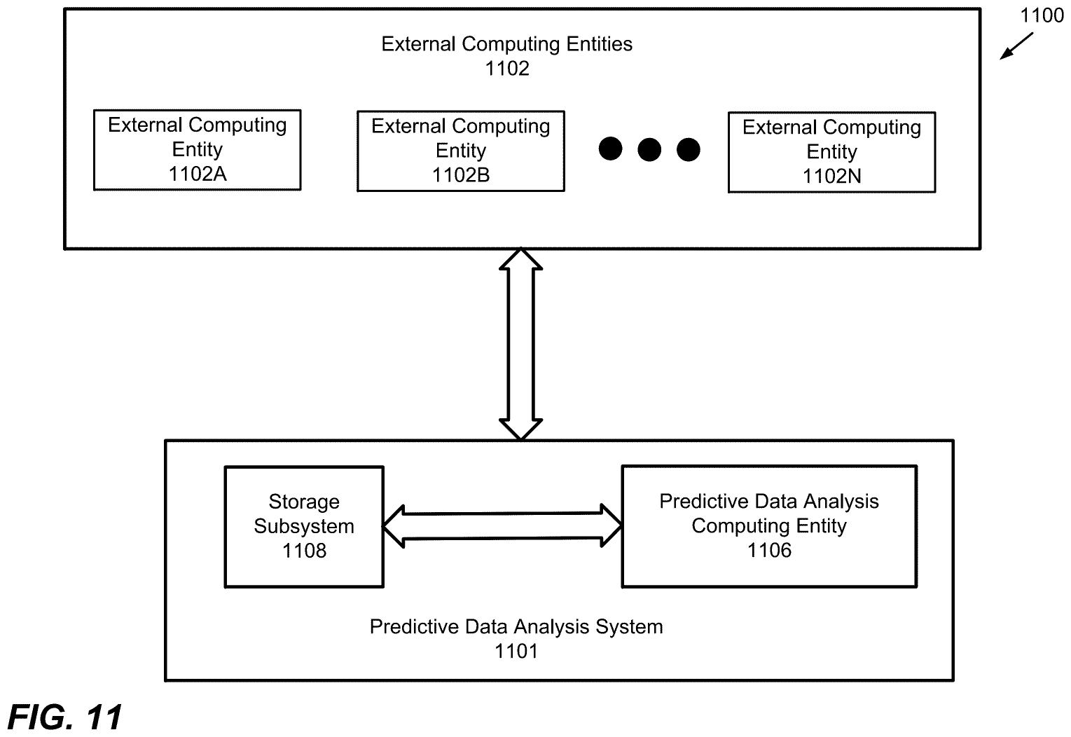

FIG. 11 provides an example overview of a system 1100 that can be used to practice embodiments of the present disclosure. The system 1100 includes a predictive data analysis system 1101 comprising a predictive data analysis computing entity 1106 configured to generate outputs that can be used to perform one or more output-based actions. The predictive data analysis system 1101 may communicate with one or more external computing entities 1102A-N using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (e.g., network routers, and/or the like).

The system 1100 includes a storage subsystem 1108 configured to store at least a portion of the data utilized by the predictive data analysis system 1101. The predictive data analysis computing entity 1106 may be in communication with the external computing entities 1102A-N. The predictive data analysis computing entity 1106 may be configured to: (i) train one or more machine learning models based on a training data store stored in the storage subsystem 1108, (ii) store trained machine learning models as part of a model definition data store of the storage subsystem 1108, (iii) use trained machine learning models to perform an action, and/or the like.

In one example, the predictive data analysis computing entity 1106 may be configured to generate a prediction, classification, and/or any other data insight based on data provided by an external computing entity such as external computing entity 1102A, external computing entity 1102B, and/or the like.

The storage subsystem 1108 may be configured to store the model definition data store and the training data store for one or more machine learning models. The predictive data analysis computing entity 1106 may be configured to receive requests and/or data from at least one of the external computing entities 1102A-N, process the requests and/or data to generate outputs (e.g., predictive outputs, classification outputs, and/or the like), and provide the outputs to at least one of the external computing entities 1102A-N. In some embodiments, the external computing entity 1102A, for example, may periodically update/provide raw and/or processed input data to the predictive data analysis system 1101. The external computing entities 1102A-N may further generate user interface data (e.g., one or more data objects) corresponding to the outputs and may provide (e.g., transmit, send, and/or the like) the user interface data corresponding with the outputs for presentation to the external computing entity 1102A (e.g., to an end-user).

The storage subsystem 1108 may be configured to store at least a portion of the data utilized by the predictive data analysis computing entity 1106 to perform one or more steps/operations and/or tasks described herein. The storage subsystem 1108 may be configured to store at least a portion of operational data and/or operational configuration data including operational instructions and parameters utilized by the predictive data analysis computing entity 1106 to perform the one or more steps/operations described herein. The storage subsystem 1108 may include one or more storage units, such as multiple distributed storage units that are connected through a computer network. Each storage unit in the storage subsystem 1108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The predictive data analysis computing entity 1106 can include an analysis engine and/or a training engine. The predictive analysis engine may be configured to perform one or more data analysis techniques. The training engine may be configured to train the predictive analysis engine in accordance with the training data store stored in the storage subsystem 108.

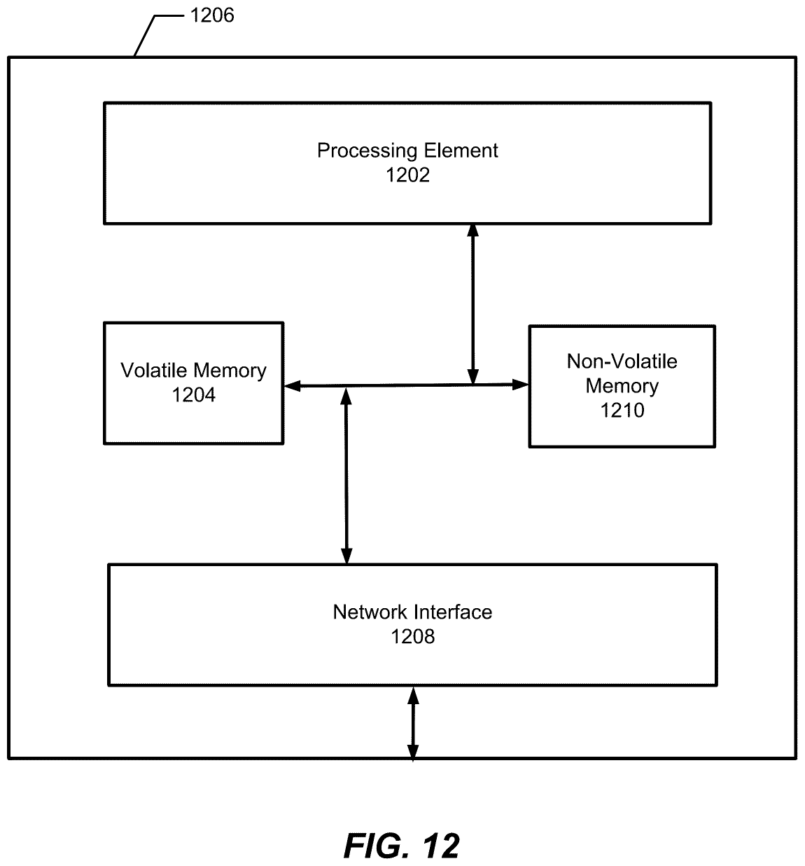

FIG. 12 provides an example predictive data analysis computing entity 1206 in accordance with some embodiments discussed herein. In general, the terms computing entity, computer, entity, device, system, and/or similar words used herein interchangeably may refer to, for example, one or more computers, computing entities, desktops, mobile phones, tablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably.

The predictive data analysis computing entity 1206 may include a network interface 1208 for communicating with various computing entities, such as by communicating data, content, information, and/or similar terms used herein interchangeably that can be transmitted, received, operated on, processed, displayed, stored, and/or the like.

In one embodiment, the predictive data analysis computing entity 1206 may include or be in communication with a processing element 1202 (also referred to as processors, processing circuitry, and/or similar terms used herein interchangeably) that communicate with other elements within the predictive data analysis computing entity 1206 via a bus, for example. As will be understood, the processing element 1202 may be embodied in a number of different ways including, for example, as at least one processor/processing apparatus, one or more processors/processing apparatuses, and/or the like.

For example, the processing element 202 may be embodied as one or more complex programmable logic devices (CPLDs), microprocessors, multi-core processors, coprocessing entities, application-specific instruction-set processors (ASIPs), microcontrollers, and/or controllers. Further, the processing element 1202 may be embodied as one or more other processing devices or circuitry. The term circuitry may refer to an entirely hardware embodiment or a combination of hardware and computer program products. Thus, the processing element 202 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 1202 may be configured for a particular use or configured to execute instructions stored in one or more memory elements including, for example, one or more volatile memories 1204 and/or non-volatile memories 1210. As such, whether configured by hardware or computer program products, or by a combination thereof, the processing element 1202 may be capable of performing steps or operations according to embodiments of the present disclosure when configured accordingly. The processing element 1202, for example in combination with the one or more volatile memories 1204 and/or or non-volatile memories 1210, may be capable of implementing one or more computer-implemented methods described herein. In some implementations, the predictive data analysis computing entity 1206 can include a computing apparatus, the processing element 1202 can include at least one processor of the computing apparatus, and the one or more volatile memories 1204 and/or non-volatile memories 1210 can include at least one memory including program code. The at least one memory and the program code can be configured to, upon execution by the at least one processor, cause the computing apparatus to perform one or more steps/operations described herein.

The non-volatile memories 1204 (also referred to as non-volatile storage, memory, memory storage, memory circuitry, media, and/or similar terms used herein interchangeably) may include at least one non-volatile memorydevice 204, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile memories 1210 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The one or more volatile memories (also referred to as volatile storage, memory, memory storage, memory circuitry, media, and/or similar terms used herein interchangeably) can include at least one volatile memory 1204 device, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile memories 1204 may be used to store at least portions of the databases, database instances, database management systems, data, applications, programs, program modules, scripts, source code, object code, byte code, compiled code, interpreted code, machine code, executable instructions, and/or the like being executed by, for example, the processing element 1202. Thus, the databases, database instances, database management systems, data, applications, programs, program modules, scripts, source code, object code, byte code, compiled code, interpreted code, machine code, executable instructions, and/or the like may be used to control certain embodiments of the operation of the predictive data analysis computing entity 106 with the assistance of the processing element 1202.

As indicated, in one embodiment, the predictive data analysis computing entity 1206 may also include the network interface 1208 for communicating with various computing entities, such as by communicating data, content, information, and/or the like that can be transmitted, received, operated on, processed, displayed, stored, and/or the like. Such communication data may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1×(1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

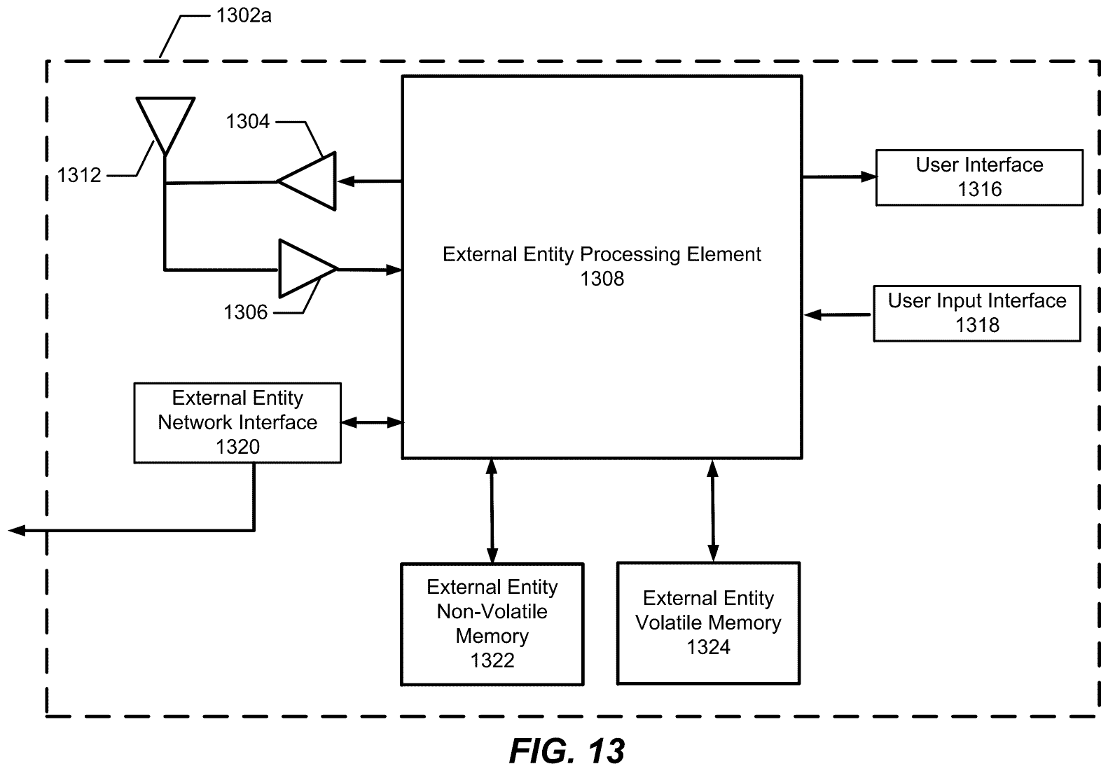

FIG. 13 provides an example external computing entity 1302A in accordance with some embodiments discussed herein. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. The external computing entities 1302A-N (corresponding to external computing entities 1102A-N can be operated by various parties. As shown in FIG. 13, the external computing entity 1302A can include an antenna 1312, a transmitter 1304 (e.g., radio), a receiver 1306 (e.g., radio), and/or an external entity processing element 1308 (e.g., CPLDs, microprocessors, multi-core processors, coprocessing entities, ASIPs, microcontrollers, and/or controllers) that provides signals to and receives signals from the transmitter 1304 and the receiver 1306, correspondingly. As will be understood, the external entity processing element 1308 may be embodied in a number of different ways including, for example, as at least one processor/processing apparatus, one or more processors/processing apparatuses, and/or the like as described herein with reference the processing element 1202.

The signals provided to and received from the transmitter 1304 and the receiver 1306, correspondingly, may include signaling information/data in accordance with air interface standards of applicable wireless systems. In this regard, the external computing entity 1302A may be capable of operating with one or more air interface standards, communication protocols, modulation types, and access types. More particularly, the external computing entity 1302A may operate in accordance with any of a number of wireless communication standards and protocols, such as those described above with regard to the predictive data analysis computing entity 1106. In a particular embodiment, the external computing entity 1302A may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 1302A may operate in accordance with multiple wired communication standards and protocols, such as those described above with regard to the predictive data analysis computing entity 1106 via an external entity network interface 1320.

Via these communication standards and protocols, the external computing entity 1302A can communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102A can also download changes, add-ons, and updates, for instance, to its firmware, software (e.g., including executable instructions, applications, program modules), operating system, and/or the like.

According to some embodiments of the disclosure, the external computing entity 1302A may include location determining embodiments, devices, modules, functionalities, and/or the like. For example, the external computing entity 1302A may include outdoor positioning embodiments, such as a location module adapted to acquire, for example, latitude, longitude, altitude, geocode, course, direction, heading, speed, universal time (UTC), date, and/or various other information/data. In one embodiment, the location module can acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the external computing entity 1302A in connection with a variety of other systems, including cellular towers, Wi-Fi access points, and/or the like. Similarly, the external computing entity 1302A may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments can be used in a variety of settings to determine the location of someone or something to within inches or centimeters.

The external computing entity 1302A may include a user interface 1316 (e.g., a display, speaker, and/or the like) that can be coupled to the external entity processing element 1308. In addition, or alternatively, the external computing entity 1302A can include a user input interface 1318 (e.g., keypad, touch screen, microphone, and/or the like) coupled to the external entity processing element 1308).

For example, the user interface 1316 may be a user application, browser, and/or similar words used herein interchangeably executing on and/or accessible via the external computing entity 1302A to interact with and/or cause the display, announcement, and/or the like of information/data to a user. The user input interface 1318 can comprise any of a number of input devices or interfaces allowing the external computing entity 1302A to receive data including, as examples, a keypad (hard or soft), a touch display, voice/speech interfaces, motion interfaces, and/or any other input device. In embodiments including a keypad, the keypad can include (or cause display of) the conventional numeric (0-9) and related keys (#, *, and/or the like), and other keys used for operating the external computing entity 1302A and may include a full set of alphabetic keys or set of keys that may be activated to provide a full set of alphanumeric keys. In addition to providing input, the user input interface 1318 can be used, for example, to activate or deactivate certain functions, such as screen savers, sleep modes, and/or the like.

The external computing entity 1302A can also include one or more external entity non-volatile memories 1322 and/or one or more external entity volatile memories 1324, which can be embedded within and/or may be removable from the external computing entity 1302A. As will be understood, the external entity non-volatile memories 1322 and/or the external entity volatile memories 1324 may be embodied in a number of different ways including, for example, as described herein with reference the volatile memory 1204 and/or the non-volatile memory 1210.

Some embodiments of the disclosure may provide methods, systems, and computer program products for generating 3D pose and/or movement estimation of a human based on 2D image information, text information, and/or music information as set forth in the following examples: Example 1: a computer-implemented method comprises performing, by one or more processors, operations comprising: converting by a pose tokenizer, based on a learned codebook, pose parameters of a body into a sequence of discrete pose tokens; randomly masking a portion of the sequence of discrete pose tokens; predicting the randomly masked sequence of discrete pose tokens based on multi-scale features extracted from a monocular image by an image conditioned masked transformer; optimizing the sequence of discrete pose tokens by aligning a re-projected three-dimensional (3D) pose with an estimated two-dimensional (2D) pose; directly regressing, from the multi-scale features, a shape parameter of the body and a weak perspective camera parameter; and generating a 3D mesh reconstruction of the body based on the shape parameter and the weak perspective camera parameter.

Example 2: the computer-implemented method of Example 1, wherein the one or more processors comprise the pose tokenizer and the image conditional masked transformer; and the method further comprises: training the pose tokenizer using Vector Quantized Variational Autoencoders (VQ-VAE).

Example 3: the computer-implemented method of any of Examples 1 and 2, wherein the post parameters comprise a representation of a continuous human pose and a representation of rotations of skeletal joints.

Example 4: the computer-implemented method of any of Examples 1-3, wherein the image conditional masked transformer comprises an image encoder and a masked transformer decoder with multi-scale deformable cross attention.

Example 5: the computer-implemented method of any of Examples 1-4, wherein optimizing the sequence comprises optimizing the sequence by using a two-dimensional pose-guided sampling strategy.

Example 6: the computer-implemented method of any of Examples 1-5, wherein the method further comprises: training the image conditional masked transformer to predict the randomly masked sequence of discrete pose tokens by learning a conditional categorical distribution of sequences of discrete pose tokens.

Example 7: the computer-implemented method of any of Examples 1-6, wherein predicting the randomly masked sequence comprises: predicting the randomly masked sequence using an iterative decoding process.

Example 8: the computer-implemented method of Example 7, wherein the iterative decoding process comprises: predicting high-confidence sequences of the discrete pose tokens; progressively refining the high-confidence sequences by masking low-confidence sequences of the discrete pose tokens; and leveraging both image semantics of the 2D image and inter-token dependencies.

Example 9: the computer-implemented method of any of Examples 1-8, wherein the 3D mesh reconstruction is used for computer vision including character animation for video games and movies, metaverse, human-computer interaction, or sports performance optimization.

Example 10: a computer-implemented method comprises performing, by one or more processors, operations comprising: extracting from a monocular image a plurality of feature tokens that encode visual information using a vision transformer encoder; extracting multi-scale image features from the encoded visual information using a multi-query deformable transformer decoder to generate a three-dimensional (3D) mesh reconstruction of a body; and applying a spatial-temporal network to the 3D mesh to infer biomechanically accurate 3D poses of the body.

Example 11: the computer-implemented method of Example 1, wherein the method further comprises: extracting the plurality of feature tokens comprises: upsampling the plurality of feature tokens to produce feature maps at a plurality of resolutions.

Example 12: the computer-implemented method of any of Examples 10-11, wherein applying the spatial-temporal network to the 3D mesh comprises: extracting virtual markers from the mesh; projecting positions of the virtual markers into a higher-dimensional space to generate a spatial embedding; and processing the spatial embedding using a plurality of convolutional layers of a spatial convolution encoder to generate a refined spatial feature embedding.

Example 13: the computer-implemented method of any of Examples 10-12, wherein the method further comprises: predicting body scales and joint angles based on the refined spatial feature embedding by modeling dependencies of the refined spatial feature embedding across a plurality of frames of a motion sequence using a temporal transformer encoder.

Example 14: the computer-implemented method of any of Examples 10-13, wherein the method further comprises: applying a loss function using a forward kinematics layer for both of the spatial convolution encoder and the temporal transformer encoder to maintain anatomical constraints in virtual markers.

Example 15: the computer-implemented method of Example 14, wherein the virtual markers are represented as a Biomechanical Skeleton (BSK) model.

Example 16: the computer-implemented method of any of Examples 10-15, wherein the method further comprises: aligning the 3D poses of the body with one or more estimated two-dimensional (2D) poses.

Example 17: a computer-implemented method comprises performing, by one or more processors, operations comprising: receiving a text prompt and a spatial control signal indicating spatial control conditions for positions of each joint of a character at each frame in a motion sequence; and creating, using a generative masked motion model, a physically plausible human motion sequence that aligns with the text prompt and follows the spatial control conditions.

Example 18: the computer-implemented method of Example 17, wherein the method further comprises: training the generative masked motion model using text training data and spatial control training data to learn a conditional distribution of motion tokens representing the joints of the character.

Example 19: the computer-implemented method of any of Examples 17-18, wherein the method further comprises: controlling a robot to move according to the physically plausible human motion sequence.

Example 20: the computer-implemented method of any of Examples 17-19, wherein the method further comprises: displaying animated graphics according to the physically plausible human motion sequence.

Example 21: the computer-implemented method of any of Examples 17-20, wherein creating the physically plausible human motion sequence comprises: processing a predicted conditional motion distribution of motion tokens representing the joints of the character so that generated motion, sampled from the plausible human motion sequence, adheres to the spatial control signal.

Example 22: the computer-implemented method of any of Examples 17-21, wherein the text prompt includes descriptions of semantic guidance for motion generation.

Example 23: the computer-implemented method of any of Examples 17-22, wherein the generative masked motion model includes: a motion tokenizer; and a text-conditioned masked transformer.

Example 24: a computer-implemented method comprises performing, by one or more processors, operations comprising: receiving a text prompt and a music control signal indicating a rhythm and spatial control conditions for positions of each joint of a character at each frame in a motion sequence; and creating, using a triple-stream masked motion model, a physically plausible human motion sequence that rhythmically aligns with the music control signal while maintaining spatial coherence.

Example 25: the computer-implemented method of Example 24, wherein the triple-stream masked motion model comprises a text-guided masked motion model, the method further comprising: training the text-guided masked motion model using text training data to learn a conditional distribution of motion tokens representing the joints of the character based on the text training data.

Example 26: the computer-implemented method of any of Examples 24-25, wherein the triple-stream masked motion model comprises a music-guided masked motion model, the method further comprising: training the music-guided motion model using music control signal training data and the text training data to learn a conditional distribution of the motion tokens representing the joints of the character based on the music control signal training data and the text training data.

Example 27: the computer-implemented method of Example 26, wherein the triple-stream masked motion model comprises a pose-guided masked motion model, the method further comprising: training the pose-guided motion model using pose control signal training data and the text training data to learn a conditional distribution of the motion tokens representing the joints of the character based on the pose control signal training data and the text training data.

Example 28: the computer-implemented method of Example 27, wherein the method further comprises: refining the motion tokens during interference to adjust rhythm synchronization and coherent alignment with multimodal inference inputs including an inference text prompt and an inference music control signal.

Example 29: a system comprises one or more processors and one or more memories configured to store processor-executable instructions that, when executed by the one or more processors, cause the one or more processors to perform operations comprising: converting by a pose tokenizer, based on a learned codebook, pose parameters of a body into a sequence of discrete pose tokens; randomly masking a portion of the sequence of discrete pose tokens; predicting the randomly masked sequence of discrete pose tokens based on multi-scale features extracted from a monocular image by an image conditioned masked transformer; optimizing the sequence of discrete pose tokens by aligning a re-projected three-dimensional (3D) pose with an estimated two-dimensional (2D) pose; directly regressing, from the multi-scale features, a shape parameter of the body and a weak perspective camera parameter; and generating a 3D mesh reconstruction of the body based on the shape parameter and the weak perspective camera parameter.

Example 30: a system comprises one or more processors and one or more memories configured to store processor-executable instructions that, when executed by the one or more processors, cause the one or more processors to perform operations comprising: extracting from a monocular image a plurality of feature tokens that encode visual information using a vision transformer encoder; extracting multi-scale image features from the encoded visual information using a multi-query deformable transformer decoder to generate a three-dimensional (3D) mesh reconstruction of a body; and applying a spatial-temporal network to the 3D mesh to infer biomechanically accurate 3D poses of the body.

Example 31: a system comprises one or more processors and one or more memories configured to store processor-executable instructions that, when executed by the one or more processors, cause the one or more processors to perform operations comprising: receiving a text prompt and a spatial control signal indicating spatial control conditions for positions of each joint of a character at each frame in a motion sequence; and creating, using a generative masked motion model, a physically plausible human motion sequence that aligns with the text prompt and follows the spatial control conditions.

Example 32: a system comprises one or more processors and one or more memories configured to store processor-executable instructions that, when executed by the one or more processors, cause the one or more processors to perform operations comprising: receiving a text prompt and a music control signal indicating a rhythm and spatial control conditions for positions of each joint of a character at each frame in a motion sequence; and creating, using a triple-stream masked motion model, a physically plausible human motion sequence that rhythmically aligns with the music control signal while maintaining spatial coherence.

Example 33: one or more non-transitory computer-readable media are configured to store processor-executable instructions that, when executed by one or more processors, cause the one or more processors to perform operations comprising: converting by a pose tokenizer, based on a learned codebook, pose parameters of a body into a sequence of discrete pose tokens; randomly masking a portion of the sequence of discrete pose tokens; predicting the randomly masked sequence of discrete pose tokens based on multi-scale features extracted from a monocular image by an image conditioned masked transformer; optimizing the sequence of discrete pose tokens by aligning a re-projected three-dimensional (3D) pose with an estimated two-dimensional (2D) pose; directly regressing, from the multi-scale features, a shape parameter of the body and a weak perspective camera parameter; and generating a 3D mesh reconstruction of the body based on the shape parameter and the weak perspective camera parameter.

Example 34: one or more non-transitory computer-readable media are configured to store processor-executable instructions that, when executed by one or more processors, cause the one or more processors to perform operations comprising: extracting from a monocular image a plurality of feature tokens that encode visual information using a vision transformer encoder; extracting multi-scale image features from the encoded visual information using a multi-query deformable transformer decoder to generate a three-dimensional (3D) mesh reconstruction of a body; and applying a spatial-temporal network to the 3D mesh to infer biomechanically accurate 3D poses of the body.

Example 35: one or more non-transitory computer-readable media are configured to store processor-executable instructions that, when executed by one or more processors, cause the one or more processors to perform operations comprising: receiving a text prompt and a spatial control signal indicating spatial control conditions for positions of each joint of a character at each frame in a motion sequence; and creating, using a generative masked motion model, a physically plausible human motion sequence that aligns with the text prompt and follows the spatial control conditions.

Example 36: one or more non-transitory computer-readable media are configured to store processor-executable instructions that, when executed by one or more processors, cause the one or more processors to perform operations comprising: receiving a text prompt and a music control signal indicating a rhythm and spatial control conditions for positions of each joint of a character at each frame in a motion sequence; and creating, using a triple-stream masked motion model, a physically plausible human motion sequence that rhythmically aligns with the music control signal while maintaining spatial coherence.

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

As used herein, the term “and/or” includes any and all combinations of one or more of the associated listed items.

The embodiments of the present disclosure have been presented for purposes of illustration and description, but are not intended to be exhaustive or limited to the disclosure in the form disclosed. Many modifications and variations may be apparent to those of ordinary skill in the art without departing from the scope and spirit of the disclosure. The aspects of the disclosure herein were chosen and described to best explain the principles of the disclosure and the practical application thereof, and to enable others of ordinary skill in the art to understand the disclosure with various modifications as are suited to the particular use contemplated.

1. A computer-implemented method comprises performing, by one or more processors, operations comprising:
converting by a pose tokenizer, based on a learned codebook, pose parameters of a body into a sequence of discrete pose tokens;
randomly masking a portion of the sequence of discrete pose tokens;
predicting the randomly masked sequence of discrete pose tokens based on multi-scale features extracted from a monocular image by an image conditioned masked transformer;
optimizing the sequence of discrete pose tokens by aligning a re-projected three-dimensional (3D) pose with an estimated two-dimensional (2D) pose;
directly regressing, from the multi-scale features, a shape parameter of the body and a weak perspective camera parameter; and
generating a 3D mesh reconstruction of the body based on the shape parameter and the weak perspective camera parameter.

2. The computer-implemented method of claim 1, wherein the one or more processors comprise the pose tokenizer and the image conditional masked transformer; and
wherein the method further comprises:
training the pose tokenizer using Vector Quantized Variational Autoencoders (VQ-VAE).

3. The computer-implemented method of claim 1, wherein the post parameters comprise a representation of a continuous human pose and a representation of rotations of skeletal joints.

4. The computer-implemented method of claim 1, wherein the image conditional masked transformer comprises an image encoder and a masked transformer decoder with multi-scale deformable cross attention.

5. The computer-implemented method of claim 1, wherein optimizing the sequence comprises optimizing the sequence by using a two-dimensional pose-guided sampling strategy.

6. The computer-implemented method of claim 1, further comprising:
training the image conditional masked transformer to predict the randomly masked sequence of discrete pose tokens by learning a conditional categorical distribution of sequences of discrete pose tokens.

7. The computer-implemented method of claim 1, wherein predicting the randomly masked sequence comprises:
predicting the randomly masked sequence using an iterative decoding process.

8. The computer-implemented method of claim 7, wherein the iterative decoding process comprises:
predicting high-confidence sequences of the discrete pose tokens;
progressively refining the high-confidence sequences by masking low-confidence sequences of the discrete pose tokens; and
leveraging both image semantics of the 2D image and inter-token dependencies.

9-16. (canceled)

17. A computer-implemented method comprises performing, by one or more processors, operations comprising:
receiving a text prompt and a spatial control signal indicating spatial control conditions for positions of each joint of a character at each frame in a motion sequence; and
creating, using a generative masked motion model, a physically plausible human motion sequence that aligns with the text prompt and follows the spatial control conditions.

18. The computer-implemented method of claim 17, further comprising:
training the generative masked motion model using text training data and spatial control training data to learn a conditional distribution of motion tokens representing the joints of the character.

19. The computer-implemented method of claim 17, further comprising:
controlling a robot to move according to the physically plausible human motion sequence.

20. The computer-implemented method of claim 17, further comprising:
displaying animated graphics according to the physically plausible human motion sequence.

21. The computer-implemented method of claim 17, wherein creating the physically plausible human motion sequence comprises:
processing a predicted conditional motion distribution of motion tokens representing the joints of the character so that generated motion, sampled from the plausible human motion sequence, adheres to the spatial control signal.

22. The computer-implemented method of claim 17, wherein the text prompt includes descriptions of semantic guidance for motion generation.

23. The computer-implemented method of claim 17, wherein the generative masked motion model includes:
a motion tokenizer; and
a text-conditioned masked transformer.

24. A computer-implemented method comprises performing, by one or more processors, operations comprising:
receiving a text prompt and a music control signal indicating a rhythm and spatial control conditions for positions of each joint of a character at each frame in a motion sequence; and
creating, using a triple-stream masked motion model, a physically plausible human motion sequence that rhythmically aligns with the music control signal while maintaining spatial coherence.

25. The computer-implemented method of claim 24, wherein the triple-stream masked motion model comprises a text-guided masked motion model, the method further comprising:
training the text-guided masked motion model using text training data to learn a conditional distribution of motion tokens representing the joints of the character based on the text training data.

26. The computer-implemented method of claim 25, wherein the triple-stream masked motion model comprises a music-guided masked motion model, the method further comprising:
training the music-guided motion model using music control signal training data and the text training data to learn a conditional distribution of the motion tokens representing the joints of the character based on the music control signal training data and the text training data.

27. The computer-implemented method of claim 26, wherein the triple-stream masked motion model comprises a pose-guided masked motion model, the method further comprising:
training the pose-guided motion model using pose control signal training data and the text training data to learn a conditional distribution of the motion tokens representing the joints of the character based on the pose control signal training data and the text training data.

28. The computer-implemented method of claim 27, further comprising:
refining the motion tokens during interference to adjust rhythm synchronization and coherent alignment with multimodal inference inputs including an inference text prompt and an inference music control signal.

29-36. (canceled)
